(19) United States
(12) Patent Application Publication
(10) Pub. No.: US 2026/0288278 A1
(43) Pub. Date: Sep. 24, 2026

(54) ELECTRONIC DEVICE

(71) Applicant: Samsung Display Co., Ltd., Yongin-si (KR)

(72) Inventors: Hyunjee JEON, Yongin-si (KR); SANGHYUN LIM, Yongin-si (KR)

(21) Appl. No.: 19/394,289

(22) Filed: Nov. 19, 2025

(30) Foreign Application Priority Data
Mar. 18, 2025 (KR) 10-2025-0034423

(51) Int. Cl. G06F 3/041; G06F 3/044

(52) U.S. Cl. CPC G06F 3/04164; G06F 3/0443; G06F 3/0446; G06F 2203/04102; G06F 2203/04106

(57) ABSTRACT

An electronic device includes: a display panel having a first region, a bending region, and a second region, and including a display layer and a sensor layer. The sensor layer includes: a first charging electrode in the first region, and overlapping with at least one first electrode; a second charging electrode in the first region, and overlapping with at least one other first electrode; a first charging trace line electrically connected to the first charging electrode and the sensor driver, and including a first charging trace line portion in the first region, and a second charging trace line portion in the second region; and a second charging trace line electrically connected to the second charging electrode and the sensor driver, and including a third charging trace line portion in the first region, and a fourth charging trace line portion in the second region.

### CROSS-REFERENCE TO RELATED APPLICATIONS

The present application claims priority to and the benefit of Korean Patent Application No. 10-2025-0034423, filed on Mar. 18, 2025, in the Korean Intellectual Property Office, the entire disclosure of which is incorporated by reference herein.

### BACKGROUND

Aspects of embodiments of the present disclosure relate to an electronic device having an improved touch performance.

Multimedia electronic devices, such as a television, a mobile phone, a tablet computer, a laptop, a navigation system, and a game console, include a display device for displaying images. In addition to general input methods, such as a button, a keyboard, and/or a mouse, the electronic devices may include a sensor layer (e.g., an input sensor) capable of providing a touch-based input method that allows a user to easily, intuitively, and conveniently input information or commands. The sensor layer may sense a user's touch or pressure. Further, there is an increasing demand for the use of pens by users who are accustomed to inputting information using writing instruments, or for a more detailed touch input in specific application programs (e.g., application programs for sketching or drawing).

The above information disclosed in this Background section is for enhancement of understanding of the background of the present disclosure, and therefore, it may contain information that does not constitute prior art.

### SUMMARY

Embodiments of the present disclosure may be directed to an electronic device having an improved touch performance.

According to one or more embodiments of the present disclosure, an electronic device includes: a display panel having a first region, a bending region, and a second region, and including a display layer and a sensor layer; and a sensor driver configured to drive the sensor layer. The sensor layer includes: a plurality of first electrodes in the first region along a first direction; a plurality of second electrodes in the first region along a second direction crossing the first direction; a first charging electrode in the first region, and overlapping with at least one first electrode among the plurality of first electrodes; a second charging electrode in the first region, and overlapping with at least one other first electrode among the plurality of first electrodes; a first charging trace line electrically connected to the first charging electrode and the sensor driver, the first charging trace line including a first charging trace line portion in the first region and extending in the second direction, and a second charging trace line portion in the second region and extending in the first direction; and a second charging trace line electrically connected to the second charging electrode and the sensor driver, the second charging trace line including a third charging trace line portion in the first region and extending in the second direction, and a fourth charging trace line portion in the second region and extending in the first direction.

In an embodiment, a first pad region on one side and a second pad region spaced from the first pad region on another side in the first direction may be located in the second region; and the sensor layer may further include: a first charging pad in the first pad region, and electrically connected to the first charging electrode; and a second charging pad in the second pad region, and electrically connected to the second charging electrode.

In an embodiment, the sensor driver may be configured to selectively operate in a first mode for sensing a touch input, or in a second mode for sensing a pen input, and the second mode may include a charging driving mode and a pen sensing driving mode.

In an embodiment, in the charging driving mode, the sensor driver may be configured to output a first signal to the second charging pad, and output a second signal different from the first signal to the first charging pad to form a charging loop in the sensor layer.

In an embodiment, the first charging trace line may further include a fifth charging trace line portion in the first region, and extending in the first direction; and the second charging trace line may further include a sixth charging trace line portion in the first region, and extending in the first direction.

In an embodiment, a length of the fifth charging trace line portion may be shorter than a length of the second charging trace line portion; and a length of the sixth charging trace line portion may be shorter than a length of the fourth charging trace line portion.

In an embodiment, the sensor layer may further include: a (1-1)-th trace line electrically connected to the sensor driver and the at least one first electrode among the plurality of first electrodes; and a (1-2)-th trace line electrically connected to the sensor driver and the at least one other first electrode among the plurality of first electrodes.

In an embodiment, the (1-1)-th trace line may include: a first trace line portion in the first region, and extending in the second direction; and a second trace line portion in the second region, and extending in the first direction. The (1-2)-th trace line may include: a third trace line portion in the first region, and extending in the second direction; and a fourth trace line portion in the second region, and extending in the first direction.

In an embodiment, the (1-1)-th trace line may further include a fifth trace line portion in the first region, and extending in the first direction; and the (1-2)-th trace line may further include a sixth trace line portion in the first region, and extending in the first direction.

In an embodiment, a first pad region on one side and a second pad region spaced from the first pad region on another side in the first direction may be located in the second region; and the sensor layer may further include: a (1-1)-th pad in the first pad region, and electrically connected to the at least one first electrode among the plurality of first electrodes; and a (1-2)-th pad in the second pad region, and electrically connected to the at least one other first electrode among the plurality of first electrodes.

In an embodiment, the sensor driver may be configured to selectively operate in a first mode for sensing a touch input, or in a second mode for sensing a pen input, and the second mode may include a charging driving mode and a pen sensing driving mode. In the pen sensing driving mode, the sensor driver may be configured to receive a reception signal from the at least one first electrode and the at least one other first electrode among the plurality of first electrodes.

In an embodiment, the first charging trace line portion may be in direct contact with the first charging electrode; and the third charging trace line portion may be in direct contact with the second charging electrode.

According to one or more embodiments of the present disclosure, an electronic device includes: a display panel having a first region, a bending region, and a second region, and including a sensor layer; and a processor configured to control an operation of the display panel. A first pad region and a second pad region spaced from the first pad region in a first direction are located in the second region; and the sensor layer includes: a first charging electrode in the first region; a second charging electrode in the first region; a first charging pad in the first pad region, and electrically connected to the first charging electrode; a second charging pad in the second pad region, and electrically connected to the second charging electrode; a first charging trace line electrically connecting the first charging electrode and the first charging pad to each other, the first charging trace line including a first charging trace line portion in the first region and extending in a second direction crossing the first direction, and a second charging trace line portion in the second region and extending in the first direction; and a second charging trace line electrically connecting the second charging electrode and the second charging pad to each other, the second charging trace line including a third charging trace line portion in the first region and extending in the second direction, and a fourth charging trace line portion in the second region and extending in the first direction.

In an embodiment, the electronic device may further include a sensor driver configured to selectively operate in a first mode for sensing a touch input, or in a second mode for sensing a pen input. The second mode may include a charging driving mode and a pen sensing driving mode, and in the charging driving mode, the sensor driver may be configured to output a first signal to the second charging pad, and a second signal different from the first signal to the first charging pad to form a charging loop in the sensor layer.

In an embodiment, the first charging trace line may further include a fifth charging trace line portion in the first region, and extending in the first direction; and the second charging trace line may further include a sixth charging trace line portion in the first region, and extending in the first direction.

In an embodiment, a length of the fifth charging trace line portion may be shorter than a length of the second charging trace line portion; and a length of the sixth charging trace line portion may be shorter than a length of the fourth charging trace line portion.

In an embodiment, the sensor layer may further include: a plurality of first electrodes in the first region along the first direction; and a plurality of second electrodes in the first region along the second direction. The first charging electrode may overlap with at least one first electrode among the plurality of first electrodes; and the second charging electrode may overlap with at least one other first electrode among the plurality of first electrodes.

In an embodiment, the sensor layer may further include: a (1-1)-th trace line electrically connected to the at least one first electrode among the plurality of first electrodes; and a (1-2)-th trace line electrically connected to the at least one other first electrode among the plurality of first electrodes. The (1-1)-th trace line may include a first trace line portion in the first region and extending in the second direction, and a second trace line portion in the second region and extending in the first direction; and the (1-2)-th trace line may include a third trace line portion in the first region and extending in the second direction, and a fourth trace line portion in the second region and extending in the first direction.

In an embodiment, the (1-1)-th trace line may further include a fifth trace line portion in the first region, and extending in the first direction; and the (1-2)-th trace line may further include a sixth trace line portion in the first region, and extending in the first direction.

In an embodiment, the first charging trace line portion may be in direct contact with the first charging electrode; and the third charging trace line portion may be in direct contact with the second charging electrode.

However, the present disclosure is not limited to the above aspects and features, and the above and additional aspects and features will be set forth, in part, in the detailed description that follows with reference to the drawings, and in part, may be apparent therefrom, or may be learned by practicing one or more of the presented embodiments of the present disclosure.

### BRIEF DESCRIPTION OF THE DRAWING S

The above and other aspects and features of the present disclosure will be more clearly understood from the following detailed description of the illustrative, non-limiting embodiments with reference to the accompanying drawings, in which:

FIG. 1 is a block diagram of an electronic device according to an embodiment of the present disclosure;

FIG. 2A is a front perspective view of an electronic device according to an embodiment of the present disclosure;

FIG. 2B is a rear perspective view of an electronic device according to an embodiment of the present disclosure;

FIG. 3 is a perspective view of an electronic device according to an embodiment of the present disclosure;

FIG. 4 is a perspective view of an electronic device according to an embodiment of the present disclosure;

FIG. 5 is a schematic cross-sectional view of a display panel according to an embodiment of the present disclosure;

FIG. 6 illustrates an operation of an electronic device according to an embodiment of the present disclosure;

FIG. 7A is a cross-sectional view of a display panel according to an embodiment of the present disclosure;

FIG. 7B is a cross-sectional view illustrating a partial configuration of a sensor layer according to an embodiment of the present disclosure;

FIG. 8 illustrates a display panel and a circuit board according to an embodiment of the present disclosure;

FIG. 9A is a plan view illustrating a first conductive layer of a sensing unit according to an embodiment of the present disclosure;

FIG. 9B is a plan view illustrating a second conductive layer of the sensing unit according to an embodiment of the present disclosure;

FIG. 10 is an enlarged plan view of the region AA' illustrated in FIG. 9B;

FIG. 11 illustrates an operation of a sensor driver according to an embodiment of the present disclosure;

FIG. 12 illustrates an operation of a sensor driver according to an embodiment of the present disclosure;

FIG. 13 illustrates a first mode according to an embodiment of the present disclosure;

FIG. 14 illustrates a second mode, such as a charging driving mode, according to an embodiment of the present disclosure;

FIG. 15A is a graph illustrating a waveform of a first signal according to an embodiment of the present disclosure;

FIG. 15B is a graph illustrating a waveform of a second signal according to an embodiment of the present disclosure;

FIG. 16 illustrates a second mode, such as a charging driving mode, according to an embodiment of the present disclosure;

FIG. 17 illustrates a display panel according to an embodiment of the present disclosure;

FIG. 18A illustrates a second mode according to an embodiment of the present disclosure;

FIG. 18B illustrates a second mode based on one sensing unit according to an embodiment of the present disclosure; and

FIG. 19 illustrates a display panel according to an embodiment of the present disclosure.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

Further, as would be understood by a person having ordinary skill in the art, in view of the present disclosure in its entirety, each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner, unless otherwise stated or implied.

In the drawings, the relative sizes, thicknesses, and ratios of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature’s relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

Further, it should be expected that the shapes shown in the figures may vary in practice depending, for example, on tolerances and/or manufacturing techniques. Accordingly, the embodiments of the present disclosure should not be construed as being limited to the specific shapes shown in the figures, and should be construed considering changes in shapes that may occur, for example, as a result of manufacturing. As such, the shapes shown in the drawings may not depict the actual shapes of areas of the device, and the present disclosure is not limited thereto.

In the figures, the x-axis, the y-axis, and the z-axis are not limited to three axes of the rectangular coordinate system, and may be interpreted in a broader sense. For example, the x-axis, the y-axis, and the z-axis may be perpendicular to or substantially perpendicular to one another, or may represent different directions from each other that are not perpendicular to one another.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being "electrically connected" to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” "includes," "including," "has," "have," and "having," when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression "A and/or B" denotes A, B, or A and B. Expressions such as “at least one of,” when preceding a list of elements, modify the entire list of elements and do not modify the individual elements of the list. For example, the expression "at least one of a, b, or c," “at least one of a, b, and c,” and “at least one selected from the group consisting of a, b, and c” indicates only a, only b, only c, both a and b, both a and c, both b and c, all of a, b, and c, or variations thereof.

As used herein, the term "substantially," "about," and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms "use," "using," and "used" may be considered synonymous with the terms "utilize," "utilizing," and "utilized," respectively.

The electronic or electric devices and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

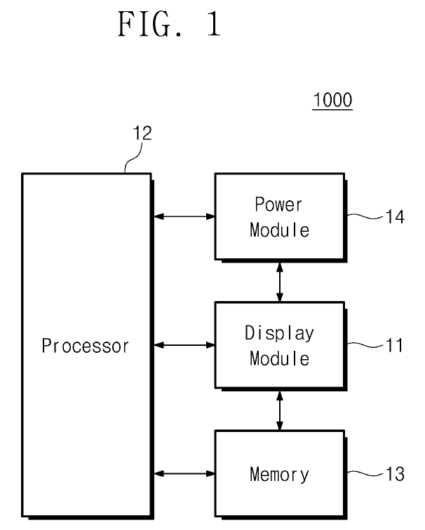

FIG. 1 is a block diagram of an electronic device 1000 according to an embodiment of the present disclosure.

Referring to FIG. 1, the electronic device 1000 according to an embodiment of the present disclosure may include a display module (e.g., a display or a touch-display) 11, a processor 12, a memory 13, and a power module (e.g., a power circuit or a power supply circuit) 14.

The display module 11 may display an image. The image may include a dynamic image as well as a still image. The processor 12 may include at least one of a central processing unit CPU, an application processor AP, a graphic processing unit GPU, a communication processor CP, an image signal processor ISP, or a controller. The processor 12 may control the operation of the display module 11.

Data information used for the operation of the processor 12 or the display module 11 may be stored in the memory 13. When the processor 12 executes an application stored in the memory 13, an image data signal and/or an input control signal may be transmitted to the display module 11, and the display module 11 may process the received signal to output image information through a display screen.

The power module 14 may include a power supply module, such as a power adapter or a battery device, and a power conversion module that converts power supplied by the power supply module to generate power used for the operation of the electronic device 1000.

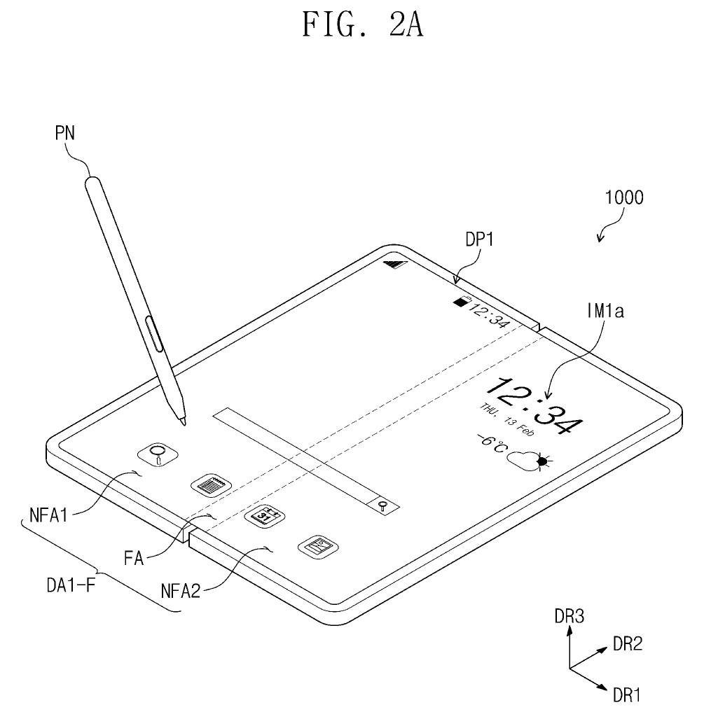

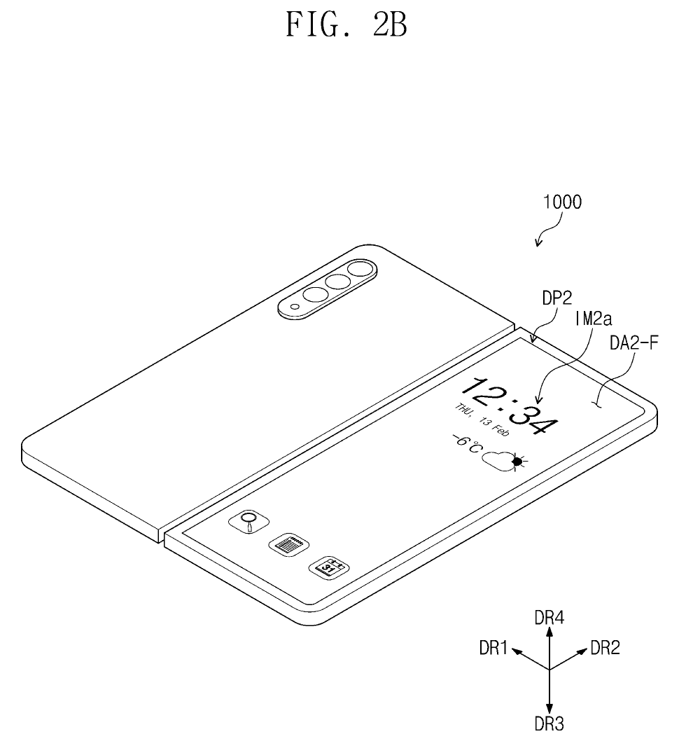

FIG. 2A is a front perspective view of the electronic device 1000 according to an embodiment of the present disclosure. FIG. 2B is a rear perspective view of the electronic device 1000 according to an embodiment of the present disclosure.

Referring to FIGS. 2A and 2B, the electronic device 1000 may be activated according to an electrical signal. For example, the electronic device 1000 may display an image, and may sense an external input applied from the outside. The external input may be a user's input. The user's input may include various suitable forms of external inputs, such as a part of the user's body, a pen PN, light, heat, or pressure.

The electronic device 1000 may include a first display panel DP1 and a second display panel DP2. The first display panel DP1 and the second display panel DP2 may be separate panels separated from each other. The first display panel DP1 may be referred to as a main display panel, and the second display panel DP2 may be referred to as an auxiliary display panel or an external display panel.

The first display panel DP1 may include a first display portion DA1-F, and the second display panel DP2 may include a second display portion DA2-F. The area of the second display panel DP2 may be smaller than the area of the first display panel DP1. Depending on the sizes of the first display panel DP1 and the second display panel DP2, the area of the first display portion DA1-F may be larger than the area of the second display portion DA2-F.

When the electronic device 1000 is unfolded, the first display portion DA1-F may have a plane that is parallel to or substantially parallel to a first direction DR1 and a second direction DR2. A thickness direction of the electronic device 1000 may be parallel to or substantially parallel to a third direction DR3 crossing the first direction DR1 and the second direction DR2. Accordingly, the front surfaces (e.g., upper surfaces) and rear surfaces (e.g., lower surfaces) of members constituting the electronic device 1000 may be defined based on the third direction DR3.

The first display panel DP1 or the first display portion DA1-F may include a folding region FA that may be folded and unfolded, and a plurality of non-folding regions NFA1 and NFA2 spaced apart from each other with the folding region FA interposed therebetween. The second display panel DP2 may overlap with any one of the plurality of non-folding regions NFA1 and NFA2. For example, the second display panel DP2 may overlap with the first non-folding region NFA1.

The display direction of a first image IM1a displayed on the first display panel DP1 and the display direction of a second image IM2a displayed on the second display panel DP2 may be opposite to each other. For example, the first image IM1a may be displayed in the third direction DR3, and the second image IM2a may be displayed in a fourth direction DR4 that is opposite to the third direction DR3.

In an embodiment of the present disclosure, the folding region FA may be bent based on a folding axis extending along a direction parallel to or substantially parallel to a long side of the electronic device 1000, for example, such as a direction parallel to or substantially parallel to the second direction DR2. When the electronic device 1000 is folded, the folding region FA has a suitable curvature (e.g., a predetermined curvature) and a suitable curvature radius (e.g., a predetermined curvature radius). The first non-folding region NFA1 and the second non-folding region NFA2 may face each other, and the electronic device 1000 may be inner-folded so that the first display portion DA1-F is not exposed to the outside.

In an embodiment of the present disclosure, the electronic device 1000 may be outer-folded so that the first display portion DA1-F is exposed to the outside. In an embodiment of the present disclosure, the electronic device 1000 may be both inner-folded or outer-folded from an unfolded state, but the present disclosure is not limited thereto.

FIG. 2A illustrates an example in which one folding region FA is defined (e.g., is provided or included) in the electronic device 1000, but the present disclosure is not limited thereto. For example, a plurality of folding axes and a plurality of folding regions corresponding thereto may be defined in the electronic device 1000, and the electronic device 1000 may be inner-folded or outer-folded from an unfolded state in each of the plurality of folding regions.

According to an embodiment of the present disclosure, at least one of the first display panel DP1 or the second display panel DP2 may sense an input by a pen PN, even though it does not include a digitizer. Accordingly, because the digitizer for sensing the pen PN may be omitted, an increase in the thickness and the weight of the electronic device 1000, as well as a decrease in the flexibility of the electronic device 1000, due to the addition of a digitizer, may not occur. Therefore, not only the first display panel DP1, but also the second display panel DP2, may be designed to sense the pen PN.

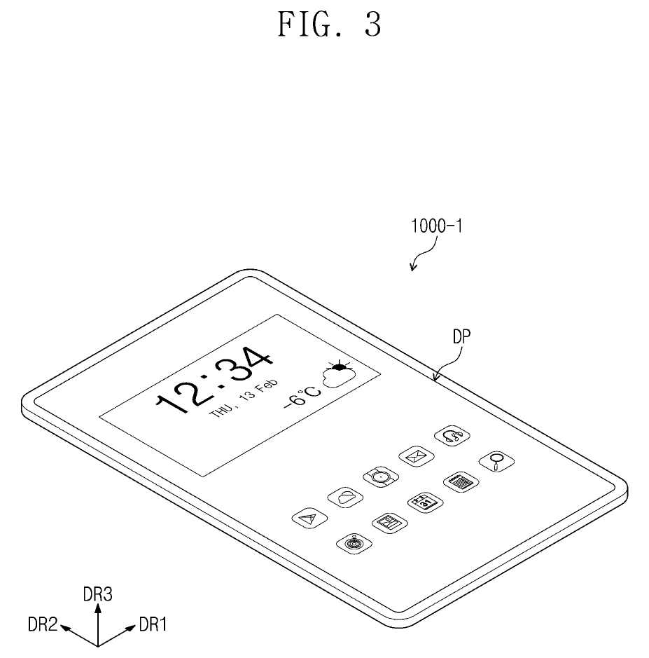

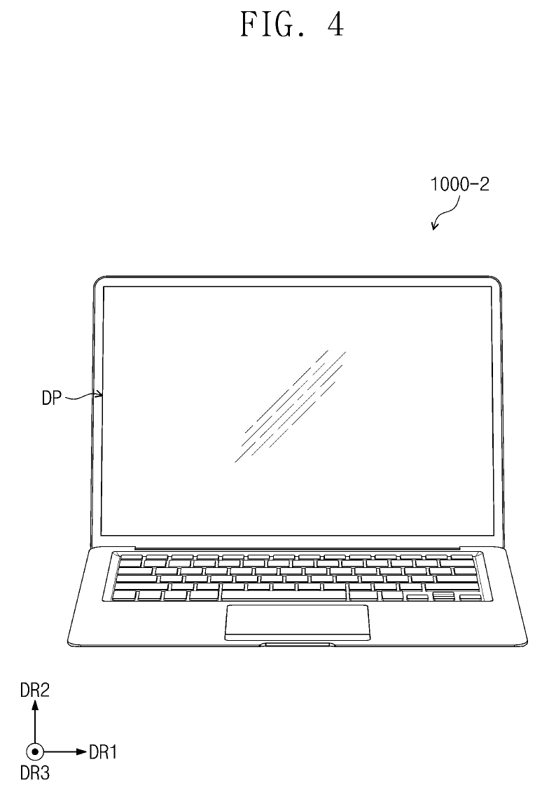

FIG. 3 is a perspective view of an electronic device 1000-1 according to an embodiment of the present disclosure. FIG. 4 is a perspective view of an electronic device 1000-2 according to an embodiment of the present disclosure.

FIG. 3 illustrates an example in which the electronic device 1000-1 is a bar-kind of mobile phone, and the electronic device 1000-1 may include a display panel DP. FIG. 4 illustrates an example in which the electronic device 1000-2 is a laptop, and the electronic device 1000-2 may include a display panel DP. FIG. 4 is a perspective view of the electronic device 1000-2, but the coordinate axes included in FIG. 4 are indicated based on the display panel DP in the electronic device 1000-2.

In an embodiment of the present disclosure, the display panel DP may sense an external input applied from the outside. The external input may be a user's input. The user's input may include various suitable forms of external inputs, such as a part of the user's body, a pen PN (e.g., see FIG. 2A), light, heat, or pressure.

According to an embodiment of the present disclosure, the display panel DP may sense an input by the pen PN, even though it does not include a digitizer. Therefore, because the digitizer for sensing the pen PN may be omitted, an increase in the thickness and the weight of the electronic device 1000-1 or 1000-2 due to the addition of a digitizer may not occur.

FIG. 2A illustrates, as an example, a foldable-kind of electronic device 1000, and FIG. 3 illustrates, as an example, a bar-kind of electronic device 1000-1, but the present disclosure is not limited thereto. For example, embodiments of the present disclosure described below may be applied to various suitable kinds of electronic devices, such as a rollable-kind of electronic device, a slidable-kind of electronic device, and a stretchable-kind of electronic device.

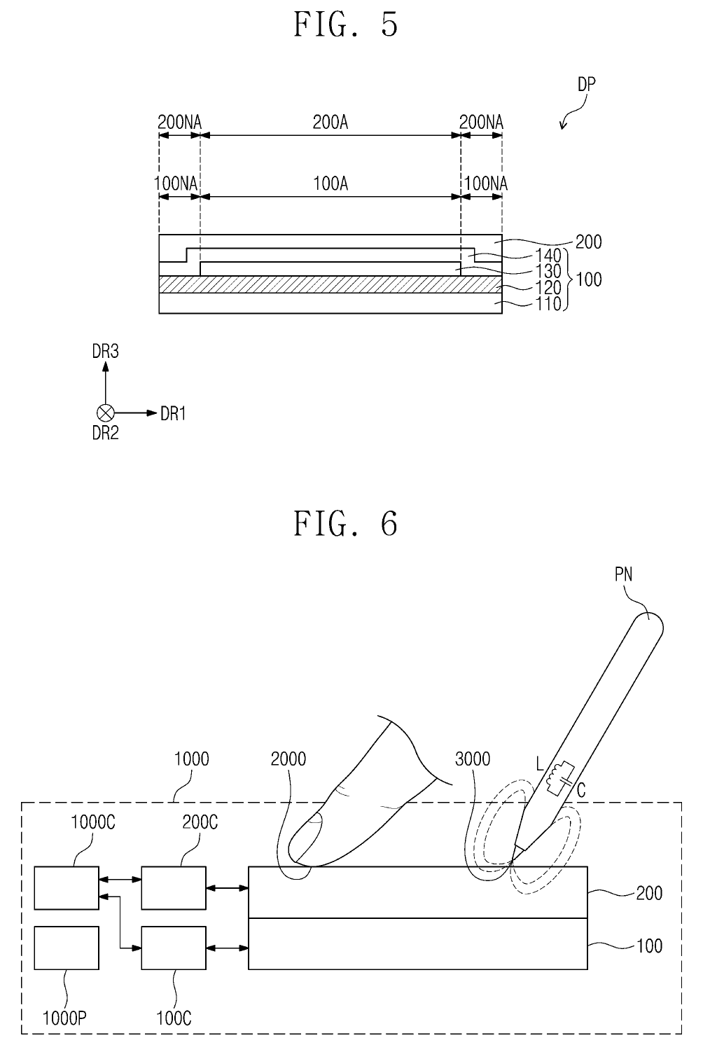

FIG. 5 is a schematic cross-sectional view of the display panel DP according to an embodiment of the present disclosure.

Referring to FIG. 5, the display panel DP may include a display layer 100 and a sensor layer 200. An upper functional member may be further disposed on the sensor layer 200. For example, the upper functional member may include at least one of an anti-reflection layer, a window, or a protective film.

The display layer 100 may be a component that generates or substantially generates an image. A display region 100A and a non-display region 100NA adjacent to the display region 100A may be defined in the display layer 100. An image may be displayed in the display region 100A

The display layer 100 may be a light-emitting display layer, for example, such as an organic light-emitting display layer, an inorganic light-emitting display layer, an organic-inorganic light-emitting display layer, a quantum dot display layer, a micro LED display layer, or a nano LED display layer. The display layer 100 may include a base layer 110, a circuit layer 120, a light-emitting element layer 130, and an encapsulation layer 140.

The base layer 110 may be a member that provides a base surface on which the circuit layer 120 is disposed. The base layer 110 may have a multi-layered structure or a single-layer structure. The base layer 110 may be a glass substrate, a metal substrate, a silicon substrate, a polymer substrate, or the like, but is not particularly limited thereto.

The circuit layer 120 may be disposed on the base layer 110. The circuit layer 120 may include an insulating layer, a semiconductor pattern, a conductive pattern, a signal line, and the like. An insulating layer, a semiconductor layer, and a conductive layer may be formed on the base layer 110 by coating, deposition, or the like, and the insulating layer, the semiconductor layer, and the conductive layer may be selectively patterned through a plurality of photolithography processes.

The light-emitting element layer 130 may be disposed on the circuit layer 120. The light-emitting element layer 130 may include a light-emitting element. For example, the light-emitting element layer 130 may include an organic light-emitting material, an inorganic light-emitting material, an organic-inorganic light-emitting material, a quantum dot, a quantum rod, a micro LED, or a nano LED.

The encapsulation layer 140 may be disposed on the light-emitting element layer 130. The encapsulation layer 140 may protect the light-emitting element layer 130 from moisture, oxygen, and foreign substances, such as dust particles.

The sensor layer 200 may be disposed on the display layer 100. A sensing region 200A and a peripheral region 200NA adjacent to the sensing region 200A may be defined in the sensor layer 200. The sensing region 200A may overlap with the display region 100A, and the peripheral region 200NA may overlap with the non-display region 100NA.

According to an embodiment of the present disclosure, the area of the sensing region 200A may be greater than or equal to the area of the display region 100A. FIG. 5 illustrates an example in which the area of the sensing region 200A and the area of the display region 100A are the same or substantially the same as each other, but the present disclosure is not limited thereto. For example, a portion of the sensing region 200A may overlap with the non-display region 100NA, and the area of the sensing region 200A may be larger than the area of the display region 100A. In this case, although an input occurs near the boundary between the display region 100A and the non-display region 100NA, a signal may be sufficiently recognized, because the sensing region 200A overlaps with a portion of the non-display region 100NA. Therefore, a coordinate accuracy for a touch input at the outer boundary of the display region 100A may be further improved.

The sensor layer 200 may sense an external input applied from the outside. The sensor layer 200 may be an integrated sensor that is continuously formed during a manufacturing process of the display layer 100, or the sensor layer 200 may be an external sensor that is attached to the display layer 100. The sensor layer 200 may be referred to as a sensor, an input sensing layer, an input sensing panel, or an electronic apparatus for sensing input coordinates.

According to an embodiment of the present disclosure, the sensor layer 200 may sense both an input from a passive-kind of input means, such as a user's body, and an input from an input device that generates a magnetic field at a suitable resonant frequency (e.g., a predetermined resonant frequency). The input device may be referred to as a pen, an input pen, a magnetic pen, a stylus pen, or an electromagnetic resonance pen.

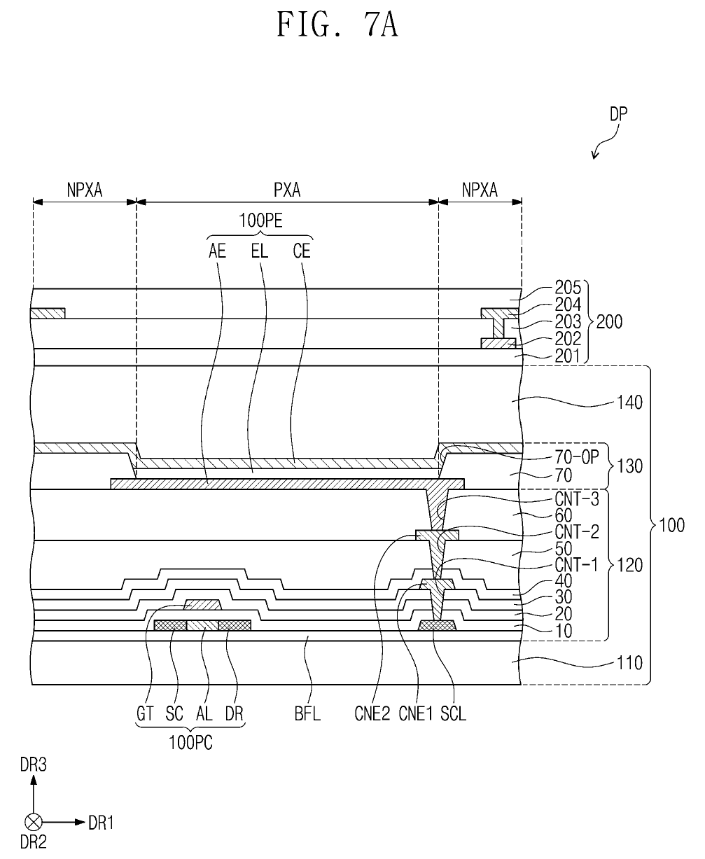

FIG. 6 illustrates an operation of the electronic device 1000 according to an embodiment of the present disclosure.

Referring to FIG. 6, the electronic device 1000 may include a display layer 100, a sensor layer 200, a display driver 100C, a sensor driver 200C, a main driver 1000C, and a power circuit 1000P.

The sensor layer 200 may sense a first input 2000 or a second input 3000 applied from the outside. Each of the first input 2000 and the second input 3000 may be an input by an input means capable of providing a change in a capacitance of the sensor layer 200, or an input by an input means capable of causing an induced current in the sensor layer 200. For example, the first input 2000 may be an input by a passive-kind of input means, such as a user's body. The second input 3000 may be an input by a pen PN, or an input by an RFIC tag. For example, the pen PN may be a passive-kind of pen or an active-kind of pen.

In an embodiment of the present disclosure, the pen PN may be a device that generates a magnetic field at a suitable resonant frequency (e.g., a predetermined resonant frequency). The pen PN may transmit an output signal based on an electromagnetic resonance method. The pen PN may be referred to as an input device, an input pen, a magnetic pen, a stylus pen, or an electromagnetic resonance pen.

The pen PN may include an RLC resonant circuit, and the RLC resonant circuit may include an inductor L and a capacitor C. In an embodiment of the present disclosure, the RLC resonant circuit may be a variable resonant circuit that varies a resonant frequency. In this case, the inductor L may be a variable inductor and/or the capacitor C may be a variable capacitor, but the present disclosure is not particularly limited thereto.

The inductor L generates a current by a magnetic field formed in the electronic device 1000, for example, such as in the sensor layer 200. However, the present disclosure is not limited thereto. For example, when the pen PN operates as an active kind, the pen PN may generate a current even though a magnetic field is not provided to it from the outside. The generated current is transmitted to the capacitor C. The capacitor C is charged by the current input from the inductor L, and discharges the stored current to the inductor L. Thereafter, the inductor L may emit a magnetic field at a resonant frequency. An induced current may flow in the sensor layer 200 by the magnetic field released by the pen PN, and the induced current may be transmitted to the sensor driver 200C as a reception signal (e.g., a sensing signal or a signal).

The main driver 1000C may control the overall operations of the electronic device 1000. For example, the main driver 1000C may control the operation of the display driver 100C and the sensor driver 200C. In other words, the main driver 1000C may control the operation of the display layer 100 and the sensor layer 200. The main driver 1000C may include at least one microprocessor, and may further include a graphic controller. The main driver 1000C may be referred to as an application processor, a central processing unit, or a main processor. The main driver 1000C may correspond to the processor 12 illustrated in FIG. 1.

The display driver 100C may drive the display layer 100. The display driver 100C may receive image data and a control signal from the main driver 1000C. The control signal may include various suitable signals. For example, the control signal may include an input vertical synchronization signal, an input horizontal synchronization signal, a main clock signal, a data enable signal, and the like.

The sensor driver 200C may drive the sensor layer 200. The sensor driver 200C may receive a control signal from the main driver 1000C. The control signal may include a clock signal of the sensor driver 200C. In addition, the control signal may further include a mode determination signal that determines driving modes of the sensor driver 200C and the sensor layer 200.

The sensor driver 200C may be implemented as an integrated circuit (IC), and electrically connected to the sensor layer 200. For example, the sensor driver 200C may be electrically connected to the sensor layer 200 by being directly mounted on a suitable region (e.g., a predetermined region) of the display panel, or by being mounted on a separate printed circuit board in a chip-on-film (COF) method.

The sensor driver 200C and the sensor layer 200 may selectively operate in a first mode or a second mode. For example, the first mode may be a mode for sensing a touch input, for example, such as the first input 2000. The second mode may be a mode for sensing a pen PN input, for example, such as the second input 3000. The first mode may be referred to as a touch sensing mode, and the second mode may be referred to as a pen sensing mode.

A conversion between the first mode and the second mode may be performed in various suitable ways. For example, the sensor driver 200C and the sensor layer 200 may be time-dividedly driven in the first mode and the second mode, and may sense the first input 2000 and the second input 3000. As another example, a conversion between the first mode and the second mode may occur due to a selection or a specific action of a user, or any one of the first mode and/or the second mode may be activated or deactivated, or converted into the other mode by an activation or a deactivation of a specific application. As another example, while the sensor driver 200C and the sensor layer 200 operate alternately in the first mode and the second mode, the first mode may be maintained when the first input 2000 is sensed, or the second mode may be maintained when the second input 3000 is sensed.

The sensor driver 200C may calculate the coordinate information of an input based on a signal received from the sensor layer 200, and may provide the main driver 1000C with a coordinate signal having the coordinate information. The main driver 1000C executes an operation corresponding to a user input based on the coordinate signal. For example, the main driver 1000C may operate the display driver 100C so that a new application image is displayed on the display layer 100.

The power circuit 1000P may include a power management integrated circuit (PMIC). The power circuit 1000P may generate a plurality of driving voltages for driving the display layer 100, the sensor layer 200, the display driver 100C, and the sensor driver 200C. For example, the plurality of driving voltages may include a gate high voltage, a gate low voltage, a first driving voltage, a second driving voltage, an initialization voltage, and the like, but the present disclosure is not particularly limited thereto.

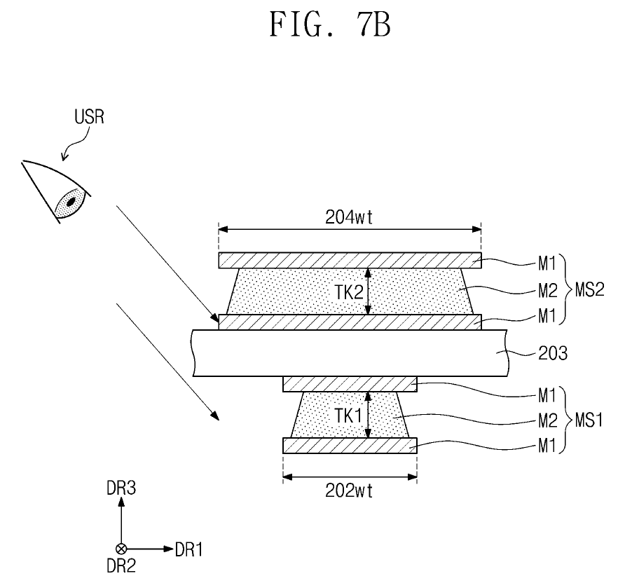

FIG. 7A is a cross-sectional view of the display panel DP according to an embodiment of the present disclosure.

Referring to FIG. 7A, at least one buffer layer BFL may be formed on the upper surface of the base layer 110. The buffer layer BFL may improve a bonding strength between the base layer 110 and a semiconductor pattern. The buffer layer BFL may be formed of a plurality of layers. As another example, the display layer 100 may further include a barrier layer. The buffer layer BFL may include at least one of silicon oxide, silicon nitride, or silicon oxynitride. For example, the buffer layer BFL may include a structure in which a silicon oxide layer and a silicon nitride layer are alternately stacked.

Semiconductor patterns SC, AL, DR, and SCL may be disposed on the buffer layer BFL. The semiconductor patterns SC, AL, DR, and SCL may include polysilicon. However, the present disclosure is not limited thereto, and the semiconductor patterns SC, AL, DR, and SCL may include amorphous silicon, a low-temperature polycrystalline silicon, or an oxide semiconductor.

FIG. 7A illustrates some of the semiconductor patterns SC, AL, DR, and SCL, and additional semiconductor patterns may be disposed in other regions. The semiconductor patterns SC, AL, DR, and SCL may be arranged in a specific rule across the pixels. The semiconductor patterns SC, AL, DR, and SCL may have different electrical properties depending on whether or not they are doped. The semiconductor patterns SC, AL, DR, and SCL may include regions SC, DR, and SCL having a higher conductivity, and a region AL having a lower conductivity. The higher conductive regions SC, DR, and SCL may be doped with an N-type dopant or a P-type dopant. A P-type transistor may include a doped region doped with the P-type dopant, and an N-type transistor may include a doped region doped with the N-type dopant. The lower conductive region AL may be a non-doped region, or a region doped at a lower concentration than those of the higher conductive regions SC, DR, and SCL.

The conductivity of the higher conductive regions SC, DR, and SCL may be greater than that of the lower conductive region AL, and the higher conductive regions SC, DR, and SCL may serve or substantially serve as an electrode or a signal line. The lower conductive region AL may correspond to or substantially correspond to an active region AL (e.g., a channel) of a transistor 100PC. In other words, a portion AL of the semiconductor patterns SC, AL, DR, and SCL may be an active region AL of the transistor 100PC, another portion SC or DR thereof may be a source region SC or drain region DR of the transistor 100PC, and another portion SCL thereof may be a connection electrode or a connection signal line SCL.

Each of the pixels may have an equivalent circuit including a plurality of transistors, at least one capacitor, and at least one light-emitting element, but the equivalent circuit diagram of a pixel may be variously modified as needed or desired. FIG. 7A illustrates, as an example, one transistor 100PC and a light-emitting element 100PE included in a pixel.

The source region SC, active region AL, and drain region DR of the transistor 100PC may be formed from the semiconductor patterns SC, AL, DR, and SCL. The source region SC and the drain region DR may extend in opposite directions from each other from the active region AL on a cross section (e.g., in a cross-sectional view). FIG. 7A illustrates a portion of the connection signal line SCL formed from the semiconductor patterns SC, AL, DR, and SCL. In another view, the connection signal line SCL may be connected to the drain region DR of the transistor 100PC on a plane (e.g., in a plan view).

A first insulating layer 10 may be disposed on the buffer layer BFL. The first insulating layer 10 may commonly overlap with a plurality of pixels, and may cover the semiconductor patterns SC, AL, DR, and SCL. The first insulating layer 10 may be an inorganic layer and/or an organic layer, and may have a single-layer or multi-layered structure. The first insulating layer 10 may include at least one of aluminum oxide, titanium oxide, silicon oxide, silicon nitride, silicon oxynitride, zirconium oxide, or hafnium oxide. In the present embodiment, the first insulating layer 10 may be a single layer of silicon oxide. Not only the first insulating layer 10, but also the insulating layers of the circuit layer 120 to be described in more detail below, may be an inorganic layer and/or an organic layer, and may have a single-layer or multi-layered structure. The inorganic layer may include at least one of the above-mentioned inorganic materials, but the present disclosure is not limited thereto.

A gate GT of the transistor 100PC may be disposed on the first insulating layer 10. The gate GT may be a portion of a metal pattern. The gate GT overlaps with the active region AL. In a process of doping or reducing the semiconductor patterns SC, AL, DR, and SCL, the gate GT may function as a mask.

A second insulating layer 20 may be disposed on the first insulating layer 10, and may cover the gate GT. The second insulating layer 20 may commonly overlap with the pixels. The second insulating layer 20 may be an inorganic layer and/or an organic layer, and may have a single-layer or multi-layered structure. The second insulating layer 20 may include at least one of silicon oxide, silicon nitride, or silicon oxynitride. In the present embodiment, the second insulating layer 20 may have a multi-layered structure including a silicon oxide layer and a silicon nitride layer.

A third insulating layer 30 may be disposed on the second insulating layer 20. The third insulating layer 30 may have a single-layer or multi-layered structure. For example, the third insulating layer 30 may have a multi-layered structure including a silicon oxide layer and a silicon nitride layer.

A first connection electrode CNE1 may be disposed on the third insulating layer 30. The first connection electrode CNE1 may be connected to the connection signal line SCL through a contact hole CNT-1 passing through the first, second, and third insulating layers 10, 20, and 30.

A fourth insulating layer 40 may be disposed on the third insulating layer 30. The fourth insulating layer 40 may be a single layer of silicon oxide. A fifth insulating layer 50 may be disposed on the fourth insulating layer 40. The fifth insulating layer 50 may be an organic layer.

A second connection electrode CNE2 may be disposed on the fifth insulating layer 50. The second connection electrode CNE2 may be connected to the first connection electrode CNE1 through a contact hole CNT-2 passing through the fourth insulating layer 40 and the fifth insulating layer 50.

A sixth insulating layer 60 may be disposed on the fifth insulating layer 50, and may cover the second connection electrode CNE2. The sixth insulating layer 60 may be an organic layer.

The light-emitting element layer 130 may be disposed on the circuit layer 120. The light-emitting element layer 130 may include a light-emitting element 100PE. For example, the light-emitting element layer 130 may include an organic light-emitting material, an inorganic light-emitting material, an organic-inorganic light-emitting material, quantum dots, quantum rods, micro LEDs, or nano LEDs. Hereinafter, for convenience of illustration, the light-emitting element 100PE may be described in more detail in the context of an organic light-emitting element, but the present disclosure is not limited thereto.

The light-emitting element 100PE may include a first electrode AE, a light-emitting layer EL, and a second electrode CE. The light-emitting element 100PE may be disposed in the display region 100A (e.g., see FIG. 5). The first electrode AE may be referred to as a pixel electrode, and the second electrode CE may be referred to as a common electrode.

The first electrode AE may be disposed on the sixth insulating layer 60. The first electrode AE may be connected to the second connection electrode CNE2 through a contact hole CNT-3 passing through the sixth insulating layer 60.

A pixel defining film 70 may be disposed on the sixth insulating layer 60, and may cover a portion of the first electrode AE. An opening 70-OP may be defined in the pixel defining film 70. The opening 70-OP of the pixel defining film 70 may expose at least a portion of the first electrode AE.

The display region 100A (e.g., see FIG. 5) may include a light-emitting region PXA, and a non-light-emitting region NPXA adjacent to the light-emitting region PXA. The non-light-emitting region NPXA may surround (e.g., around a periphery of) the light-emitting region PXA. In the present embodiment, the light-emitting region PXA is defined to correspond to a partial region of the first electrode AE exposed by the opening 70-OP.

The light-emitting layer EL may be disposed on the first electrode AE. The light-emitting layer EL may be disposed in a region corresponding to the opening 70-OP. FIG. 7A illustrates an example in which the light-emitting layer EL is disposed in the opening 70-OP, but the present disclosure is not limited thereto. For example, the light-emitting layer EL may extend to cover a portion of the side and upper surfaces of the pixel defining film 70 defining the opening 70-OP.

In an embodiment of the present disclosure, the light-emitting layer EL may be separately included for each pixel. When the light-emitting layer EL is separately formed in each pixel, each of the light-emitting layers EL may emit light of at least one color among blue, red, and/or green. However, the present disclosure is not limited thereto, and the light-emitting layer EL may have an integrated shape to be commonly included in a plurality of pixels. In this case, the light-emitting layer EL may provide blue light or white light.

The second electrode CE may be disposed on the light-emitting layer EL. The second electrode CE may have an integrated shape, and may be commonly included in a plurality of pixels.

In an embodiment of the present disclosure, a hole control layer may be disposed between the first electrode AE and the light-emitting layer EL. The hole control layer may be commonly disposed in the light-emitting region PXA and the non-light-emitting region NPXA. The hole control layer may include a hole transport layer, and may further include a hole injection layer as needed or desired. An electron control layer may be disposed between the light-emitting layer EL and the second electrode CE. The electron control layer may include an electron transport layer, and may further include an electron injection layer as needed or desired. The hole control layer and the electron control layer may be commonly formed in a plurality of pixels by using an open mask or an inkjet process.

The encapsulation layer 140 may be disposed on the light-emitting element layer 130. The encapsulation layer 140 may include an inorganic layer, an organic layer, and an inorganic layer that are sequentially stacked, but the layers constituting the encapsulation layer 140 are not limited thereto. The inorganic layers may protect the light-emitting element layer 130 from moisture and oxygen, and the organic layer may protect the light-emitting element layer 130 from foreign substances, such as dust particles. The inorganic layers may include a silicon nitride layer, a silicon oxynitride layer, a silicon oxide layer, a titanium oxide layer, an aluminum oxide layer, or the like. The organic layer may include an acrylic-based organic layer, but is not limited thereto.

The sensor layer 200 may include a base layer 201, a first conductive layer 202, an intermediate insulating layer 203, a second conductive layer 204, and a cover insulating layer 205.

The base layer 201 may be an inorganic layer including at least one of silicon nitride, silicon oxynitride, or silicon oxide. As another example, the base layer 201 may be an organic layer including an epoxy resin, an acrylic resin, or an imide- based resin. The base layer 201 may have a single-layer structure, or a multi-layered structure in which layers are stacked along the third direction DR3. In an embodiment of the present disclosure, the sensor layer 200 may not include the base layer 201.

Each of the first conductive layer 202 and the second conductive layer 204 may have a single-layer structure, or a multi-layered structure in which layers are stacked along the third direction DR3.

Each of the first conductive layer 202 and the second conductive layer 204 having a single-layer structure may include a metal layer or a transparent conductive layer. The metal layer may include molybdenum, silver, titanium, copper, aluminum, or an alloy thereof. The transparent conductive layer may include a transparent conductive oxide, such as indium tin oxide (ITO), indium zinc oxide (IZO), zinc oxide (ZnO), or indium zinc tin oxide (IZTO). In addition, the transparent conductive layer may include a conductive polymer, such as poly(3,4-ethylenedioxythiophene) (PEDOT), a metal nanowire, graphene, and/or the like.

Each of the first conductive layer 202 and the second conductive layer 204 having a multi-layered structure may include metal layers. The metal layers may have a three-layered structure of, for example, titanium/aluminum/titanium. The conductive layer having a multi-layered structure may include at least one metal layer and at least one transparent conductive layer.

In an embodiment of the present disclosure, the thickness of the first conductive layer 202 may be greater than or equal to the thickness of the second conductive layer 204. When the thickness of the first conductive layer 202 is greater than the thickness of the second conductive layer 204, a resistance of the components (e.g., an electrode, a pattern, a bridge pattern, or the like) included in the first conductive layer 202 may be reduced. In addition, because the first conductive layer 202 may be disposed below (e.g., under) the second conductive layer 204, a probability that the components included in the first conductive layer 202 may be viewed due to an external light reflection may be lower than that of the second conductive layer 204, even though the thickness of the first conductive layer 202 is increased.

At least one of the intermediate insulating layer 203 or the cover insulating layer 205 may include an inorganic film. The inorganic film may include at least one of aluminum oxide, titanium oxide, silicon oxide, silicon nitride, silicon oxynitride, zirconium oxide, or hafnium oxide.

At least one of the intermediate insulating layer 203 or the cover insulating layer 205 may include an organic film. The organic film may include at least one of an acrylic-based resin, a methacrylic-based resin, polyisoprene, a vinyl-based resin, an epoxy-based resin, a urethane-based resin, a cellulose-based resin, a siloxane-based resin, a polyimide-based resin, a polyamide-based resin, or a perylene-based resin.

While the sensor layer 200 has been described above as including the first conductive layer 202 and the second conductive layer 204, or in other words, two conductive layers in total, the present disclosure is not limited thereto. For example, the sensor layer 200 may include three or more conductive layers.

FIG. 7B is a cross-sectional view illustrating a partial configuration of the sensor layer 200 according to an embodiment of the present disclosure.

Referring to FIGS. 7A and 7B, a second width 204wt of a second mesh line MS2 included in the second conductive layer 204 may be greater than or equal to a first width 202wt of a first mesh line MS1 included in the first conductive layer 202. When a user USR views the first mesh line MS1 and the second mesh line MS2 from a side, the first mesh line MS1 has a smaller width than the second mesh line MS2, so a probability that the first mesh line MS1 is viewed by the user USR may be reduced.

Each of the first mesh line MS1 and the second mesh line MS2 may include first metal layers M1, and a second metal layer M2 disposed between the first metal layers M1. For example, the first metal layers M1 may include titanium (Ti), and the second metal layer M2 may include aluminum (Al). However, the present disclosure is not limited thereto.

In an embodiment of the present disclosure, a first thickness TK1 of the second metal layer M2 of the first mesh line MS1 and a second thickness TK2 of the second metal layer M2 of the second mesh line MS2 may be the same or substantially the same as each other, but the present disclosure is not limited thereto. For example, the first thickness TK1 may be greater than the second thickness TK2. As another example, the second thickness TK2 may be greater than the first thickness TK1. In an embodiment of the present disclosure, each of the first thickness TK1 and the second thickness TK2 may be about 1000 angstroms or more, for example, such as about 6000 angstroms.

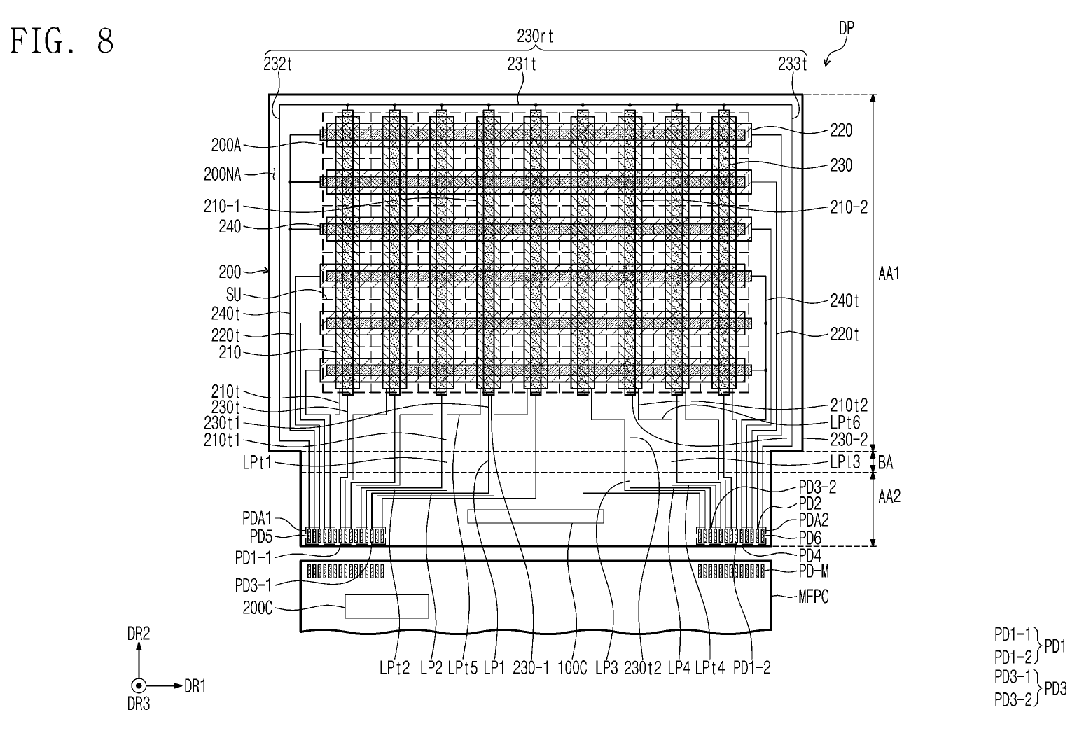

FIG. 8 illustrates the display panel DP and a circuit board MFPC according to an embodiment of the present disclosure.

Referring to FIG. 8, a first region AA1, a bending region BA, and a second region AA2 may be defined in the display panel DP. The bending region BA may be disposed between the first region AA1 and the second region AA2, which may be spaced apart from each other in the second direction DR2. The width (or length) of the second region AA2 and the width of the bending region BA parallel to or substantially parallel to the first direction DR1 may be smaller than the width (or length) of the first region AA1 parallel to or substantially parallel to the first direction DR1. A region having a shorter length in a direction of a bending axis may be bent more easily.

FIG. 8 is a plan view illustrating the display panel DP in an unfolded state before being assembled with other components, or in other words, before being modularized. A portion of the display panel DP may be bent for modularization. For example, the bending region BA of the display panel DP may be bent, and the second region AA2 may be disposed below (e.g., under) the first region AA1.

The display driver 100C may be mounted on the second region AA2 of the display panel DP. The display driver 100C may include driving elements, such as a data driving circuit, for driving the pixels included in the display layer 100 (e.g., see FIG. 6) of the display panel DP.

The circuit board MFPC may be coupled to the second region AA2 of the display panel DP. The circuit board MFPC may be electrically connected to pads PD1, PD2, PD3, PD4, PD5, and PD6 of the display panel DP through an anisotropic conductive adhesive layer. However, the present disclosure is not limited thereto. For example, pads PD-M of the circuit board MFPC may be directly coupled to the pads PD1, PD2, PD3, PD4, PD5, and PD6 of the display panel DP. The circuit board MFPC may be referred to as a flexible circuit board, a flexible circuit film, a multi-layered flexible board, or a multi-layered flexible film.

The sensor driver 200C may be mounted on the circuit board MFPC. FIG. 8 illustrates, as an example, a structure in which the display driver 100C is mounted on the display panel DP and the sensor driver 200C is mounted on the circuit board MFPC, but the present disclosure is not limited thereto. For example, the display driver 100C may also be mounted on the circuit board MFPC.

The display panel DP may include the sensor layer 200. A sensing region 200A and a peripheral region 200NA adjacent to the sensing region 200A may be defined in the sensor layer 200. The first region AA1 may overlap with the sensing region 200A and a portion of the peripheral region 200NA. The bending region BA and the second region AA2 may overlap with another portion of the peripheral region 200NA.

The sensor layer 200 may include a plurality of first electrodes 210, a plurality of second electrodes 220, a plurality of third electrodes 230, and a plurality of fourth electrodes 240 disposed in the first region AA1 and the sensing region 200A.

Each of the first electrodes 210 may cross the second electrodes 220. Each of the first electrodes 210 may extend along the second direction DR2, and the first electrodes 210 may be arranged to be spaced apart from each other along the first direction DR1. Each of the second electrodes 220 may extend along the first direction DR1, and the second electrodes 220 may be arranged to be spaced apart from each other along the second direction DR2. A sensing unit (e.g., a sensing area) SU of the sensor layer 200 may be a region in which one first electrode 210 and one second electrode 220 cross each other.

In FIG. 8, nine first electrodes 210 and six second electrodes 220 are illustrated as an example, and thus, 54 sensing units SU are illustrated as an example, but the number of first electrodes 210 and the number of second electrodes 220 are not limited thereto.

Each of the third electrodes 230 may extend along the second direction DR2, and the third electrodes 230 may be arranged to be spaced apart from each other along the first direction DR1. One third electrode 230 may at least partially overlap with one first electrode 210. According to an embodiment of the present disclosure, by adjusting the overlapping area between one first electrode 210 and one third electrode 230, it may be possible to adjust a capacitance (e.g., a coupling capacitance) between the one first electrode 210 and the one third electrode 230. Hereinafter, the third electrodes 230 may be referred to as charging electrodes 230.

In an embodiment of the present disclosure, the charging electrodes 230 may include a first charging electrode 230-1 and a second charging electrode 230-2. The first charging electrode 230-1 may overlap with at least one first electrode 210-1 among the first electrodes 210. The second charging electrode 230-2 may overlap with at least one other first electrode 210-2 among the first electrodes 210. The first charging electrode 230-1 may be spaced apart from the second charging electrode 230-2 in the first direction DR1.

The fourth electrodes 240 may be arranged along the second direction DR2, and the fourth electrodes 240 may extend in the first direction DR1. One fourth electrode 240 may at least partially overlap with one second electrode 220. According to an embodiment of the present disclosure, by adjusting the overlapping area between one second electrode 220 and one fourth electrode 240, it may be possible to adjust a capacitance (e.g., a coupling capacitance) between the one second electrode 220 and the one fourth electrode 240.

In an embodiment of the present disclosure, at least some of the fourth electrodes 240 may be electrically connected to each other to form one electrode group. FIG. 8 illustrates an example in which three fourth electrodes 240 are connected to a single trace line, for example, such as an auxiliary trace line 240t, to form one electrode group. Accordingly, FIG. 8 illustrates that two electrode groups are arranged along the second direction DR2. However, the number of fourth electrodes 240 forming one electrode group is not limited thereto. For example, the number of fourth electrodes 240 forming one electrode group may be six, and in this case, the sensor layer 200 may include only one electrode group.

In an embodiment of the present disclosure, a first pad region PDA1 disposed on one side and a second pad region PDA2 spaced apart from the first pad region PDA1 in the first direction DR1 may be defined in the second region AA2. The pads PD1, PD2, PD3, PD4, PD5, and PD6 electrically connected to the first to fourth electrodes 210, 220, 230, and 240 may be disposed in the first pad region PDA1 and the second pad region PDA2. FIG. 8 illustrates an example in which two pad regions PDA1 and PDA2 are defined in the second region AA2, but the present disclosure is not limited thereto, and in an embodiment of the present disclosure, three or more pad regions may be defined in the second region AA2.

The sensor layer 200 may further include a plurality of first trace lines 210t disposed in the peripheral region 200NA, a plurality of first pads PD1 connected in a one-to-one correspondence with the first trace lines 210t, a plurality of second trace lines 220t, and a plurality of second pads PD2 connected in a one-to-one correspondence with the second trace lines 220t. The first trace lines 210t may be electrically connected in a one-to-one correspondence with the first electrodes 210. The second trace lines 220t may be electrically connected in a one-to-one correspondence with the second electrodes 220.

In an embodiment of the present disclosure, the first trace lines 210t may include a (1-1)-th trace line 210t1 and a (1-2)-th trace line 210t2. The (1-1)-th trace line 210t1 may be electrically connected to at least one first electrode 210-1 among the first electrodes 210 and to the sensor driver 200C. The (1-2)-th trace line 210t2 may be electrically connected to at least one other first electrode 210-2 among the first electrodes 210 and to the sensor driver 200C. In other words, the first electrode 210-1 electrically connected to the (1-1)-th trace line 210t1 may overlap with the first charging electrode 230-1, and the first electrode 210-2 electrically connected to the (1-2)-th trace line 210t2 may overlap with the second charging electrode 230-2.

In an embodiment of the present disclosure, the (1-1)-th trace line 210t1 may include a first trace line portion LPt1 disposed in the first region AA1 and extending in the second direction DR2, and a second trace line portion LPt2 disposed in the second region AA2 and extending in the first direction DR1. The (1-2)-th trace line 210t2 may include a third trace line portion LPt3 disposed in the first region AA1 and extending in the second direction DR2, and a fourth trace line portion LPt4 disposed in the second region AA2 and extending in the first direction DR1. In addition, the (1-1)-th trace line 210t1 may further include a fifth trace line portion LPt5 disposed in the first region AA1 and extending in the first direction DR1, and the (1-2)-th trace line 210t2 may further include a sixth trace line portion LPt6 disposed in the first region AA1 and extending in the first direction DR1.

FIG. 8 illustrates an example in which the (1-1)-th trace line 210t1 includes a first trace line portion LPt1, a second trace line portion LPt2, and a fifth trace line portion LPt5, and the (1-2)-th trace line 210t2 includes a third trace line portion LPt3, a fourth trace line portion LPt4, and a sixth trace line portion LPt6, but the present disclosure is not limited thereto, and at least some of the trace line portions may be omitted as needed or desired.

In an embodiment of the present disclosure, the first pads PD1 may include a (1-1)-th pad PD1-1 and a (1-2)-th pad PD1-2. The (1-1)-th pad PD1-1 may be disposed in the first pad region PDA1, and may be electrically connected to at least one first electrode 210-1 among the first electrodes 210. The (1-2)-th pad PD1-2 may be disposed in the second pad region PDA2, and may be electrically connected to at least one other first electrode 210-2 among the first electrodes 210. In other words, the first electrode 210-1 electrically connected to the (1-1)-th pad PD1-1 may overlap with the first charging electrode 230-1, and the first electrode 210-2 electrically connected to the (1-2)-th pad PD1-2 may overlap with the second charging electrode 230-2.

The sensor layer 200 may further include a plurality of third trace lines 230t disposed in the peripheral region 200NA, a plurality of third pads PD3 connected in a one-to-one correspondence with the third trace lines 230t, a plurality of fourth trace lines 240t, and a plurality of fourth pads PD4 connected in a one-to-one correspondence with the fourth trace lines 240t. The third trace lines 230t may be referred to as charging trace lines 230t, and the third pads PD3 may be referred to as charging pads PD3.

The charging trace lines 230t may include a first charging trace line 230t1 and a second charging trace line 230t2.

In an embodiment of the present disclosure, the first charging trace line 230t1 may be electrically connected to the first charging electrode 230-1 and the sensor driver 200C. The first charging trace line 230t1 may include a first charging trace line portion LP1 disposed in the first region AA1 and extending in the second direction DR2, and a second charging trace line portion LP2 disposed in the second region AA2 and extending in the first direction DR1.

In an embodiment of the present disclosure, the second charging trace line 230t2 may be electrically connected to the second charging electrode 230-2 and the sensor driver 200C. The second charging trace line 230t2 may include a third charging trace line portion LP3 disposed in the first region AA1 and extending in the second direction DR2, and a fourth charging trace line portion LP4 disposed in the second region AA2 and extending in the first direction DR1.

In an embodiment of the present disclosure, the first charging trace line portion LP1 of the first charging trace line 230t1 may be in direct contact with the first charging electrode 230-1, and the third charging trace line portion LP3 of the second charging trace line 230t2 may be in direct contact with the second charging electrode 230-2.

In an embodiment of the present disclosure, the charging pads PD3 may include a first charging pad PD3-1 and a second charging pad PD3-2. The first charging pad PD3-1 may be disposed in the first pad region PDA1, and may be electrically connected to the first charging electrode 230-1. The second charging pad PD3-2 may be disposed in the second pad region PDA2, and may be electrically connected to the second charging electrode 230-2. In other words, the first charging trace line 230t1 may electrically connect the first charging pad PD3-1 disposed in the first pad region PDA1 and the first charging electrode 230-1 to each other, and the second charging trace line 230t2 may electrically connect the second charging pad PD3-2 disposed in the second pad region PDA2 and the second charging electrode 230-2 to each other.

According to some embodiments of the present disclosure, in the first region AA1, the first charging trace line 230t1 and the second charging trace line 230t2 may extend in the second direction DR2 that is the same as the extension direction of the first charging electrode 230-1 and the second charging electrode 230-2. In other words, in the first region AA1, the first charging trace line 230t1 and the second charging trace line 230t2 may not extend in the first direction DR1 that crosses the extension direction of the first charging electrode 230-1 and the second charging electrode 230-2. Therefore, in the first region AA1, although the first charging trace line 230t1 and the second charging trace line 230t2 extend toward pad regions spaced apart from each other, a current flowing through the first charging trace line 230t1, the first charging electrode 230-1, the second charging electrode 230-2, and the second charging trace line 230t2 in the first region AA1 may flow in a constant loop direction. In this case, in the first region AA1, the current flowing in a constant loop direction may reinforce a magnetic field. For example, when the pen PN (e.g., see FIG. 6) is charged, the current flowing in a constant loop direction may generate a magnetic field in the same direction, thereby reinforcing the magnetic field, which may improve the charging performance of the pen PN (e.g., see FIG. 6).

In addition, in the second region AA2, the first charging trace line 230t1 and the second charging trace line 230t2 may extend in the first direction DR1 crossing the extension direction of the first charging electrode 230-1 and the second charging electrode 230-2, but the second region AA2 may be bent below (e.g., under) the first region AA1 by the bending region BA. In this case, because a region between the first region AA1 and the second region AA2 is shielded, although the first charging trace line 230t1 and the second charging trace line 230t2 extend in the first direction DR1 in the second region AA2, the first region AA1 may not be affected. In other words, when the first charging trace line 230t1 and the second charging trace line 230t2 extend in the second direction DR2 that is the same as the extension direction of the first charging electrode 230-1 and the second charging electrode 230-2 in the first region AA1, a touch performance of the electronic device 1000 (e.g., see FIG. 1) may be improved.

In an embodiment of the present disclosure, in a state in which the bending region BA of the display panel DP is bent, a magnetic field shielding layer may be further disposed between the first region AA1 and the second region AA2 of the display panel DP. The magnetic field shielding layer may include a magnetic metal powder. The magnetic field shielding layer may be referred to as a ferrite sheet, a magnetic metal powder layer, a magnetic layer, a magnetic circuit layer, or a magnetic path layer. The magnetic field shielding layer may shield a magnetic field from the first region AA1 of the display panel DP toward the second region AA2 of the display panel DP. In addition, the magnetic field shielding layer may shield a magnetic field from the second region AA2 of the display panel DP toward the first region AA1 of the display panel DP.

The charging trace lines 230t may be connected to the charging electrodes 230 in a one-to-one correspondence. In other words, the number of charging trace lines 230t may correspond to the number of charging electrodes 230. FIG. 8 illustrates, as an example, nine charging trace lines 230t and nine charging electrodes 230.

In another embodiment of the present disclosure, one charging trace line may be electrically connected to a plurality of charging electrodes. The plurality of charging electrodes connected to one charging trace line may be referred to as one electrode group. In this case, as the number of parallel-connected charging electrodes included in one electrode group increases, a resistance of the electrode group decreases, thereby improving a power efficiency and enhancing a sensing sensitivity. On the other hand, as the number of charging electrodes included in one electrode group decreases, a loop coil pattern formed using the electrode group may be implemented in more diverse forms.

The sensor layer 200 may further include a loop trace line 230rt disposed in the peripheral region 200NA, a fifth pad PD5 connected to one end of the loop trace line 230rt, and a sixth pad PD6 connected to another end of the loop trace line 230rt.

The loop trace line 230rt may be electrically connected to the charging electrodes 230. In an embodiment of the present disclosure, the loop trace line 230rt may be electrically connected to all of the charging electrodes 230. The loop trace line 230rt may include a first line portion 231t extending in the first direction DR1 and electrically connected to the charging electrodes 230, a second line portion 232t extending parallel to or substantially parallel to the second direction DR2 from a first end of the first line portion 231t, and a third line portion 233t extending parallel to or substantially parallel to the second direction DR2 from a second end of the first line portion 231t.

In an embodiment of the present disclosure, each of resistances of the second line portion 232t and the third line portion 233t may be equal to or substantially equal to a resistance of one of the charging electrodes 230. Therefore, the second line portion 232t and the third line portion 233t may serve as the charging electrodes 230, enabling the same effect as when the charging electrodes 230 are also disposed in the peripheral region 200NA. For example, any one of the second line portion 232t and/or the third line portion 233t and any one of the charging electrodes 230 may form a coil. Therefore, a pen located in a region adjacent to the peripheral region 200NA may also be sufficiently charged by a loop including the second line portion 232t or the third line portion 233t.

In an embodiment of the present disclosure, in order to adjust the resistance of the second line portion 232t and the resistance of the third line portion 233t, the width of each of the second line portion 232t and the third line portion 233t in the first direction DR1 may be adjusted. However, the present disclosure is not limited thereto, and the first to third line portions 231t, 232t, and 233t may have the same or substantially the same width as each other.

The fourth trace lines 240t may be spaced apart from each other with the sensing region 200A interposed therebetween. FIG. 8 illustrates an example in which two electrode groups are arranged. The fourth trace line 240t connected to three fourth electrodes 240 disposed on the upper side and the fourth trace line 240t connected to three fourth electrodes 240 disposed on the lower side may be spaced apart from each other with the sensing region 200A interposed therebetween. However, the present disclosure is not limited thereto.

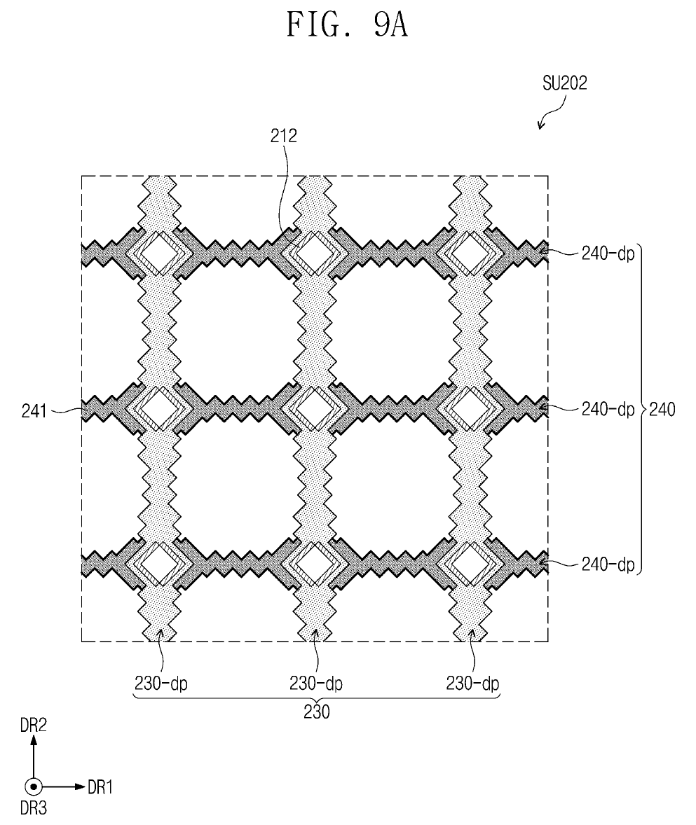

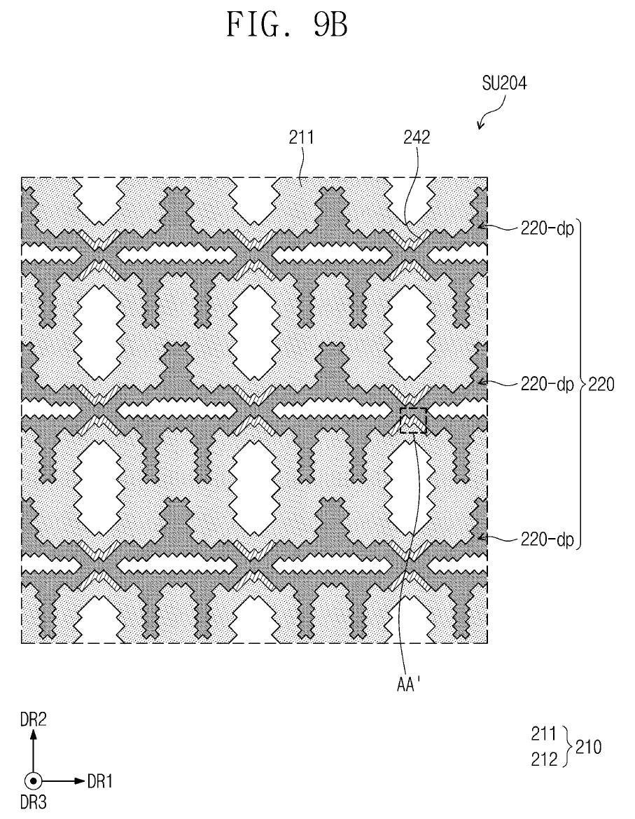

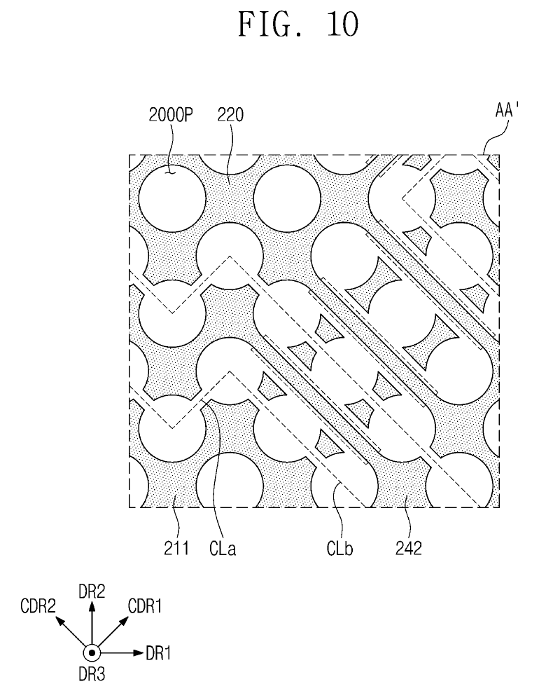

FIG. 9A is a plan view illustrating a first conductive layer SU202 of the sensing unit SU according to an embodiment of the present disclosure. FIG. 9B is a plan view illustrating a second conductive layer SU204 of the sensing unit SU according to an embodiment of the present disclosure. FIG. 10 is an enlarged plan view of the region AA' illustrated in FIG. 9B.

In FIGS. 9A and 9B, the shape of a mesh structure is not illustrated, and boundaries of the components are schematically illustrated by lines. In other words, the lines illustrated in FIGS. 9A and 9B may be understood as corresponding to the lines with the mesh structure removed in FIG. 10, and lines CLa and CLb are illustrated as dotted lines in FIG. 10.

The shape and mesh structure of the sensing unit SU illustrated in FIGS. 9A, 9B, and 10 are provided as examples, and the present disclosure is not limited thereto. The shape and the mesh structure of the sensing unit SU may be variously modified as needed or desired.

Referring to FIGS. 9A and 9B, the first electrode 210 may include a plurality of first patterns 211, and a plurality of first bridge patterns 212 electrically connected to the first patterns 211. The first patterns 211 arranged to be spaced apart from each other in the second direction DR2 may be electrically connected to each other by the first bridge patterns 212. The first patterns 211 may be included in the second conductive layer SU204, and the first bridge patterns 212 may be included in the first conductive layer SU202.

In one first electrode 210, two first patterns 211 adjacent to each other in the second direction DR2 may be electrically connected to each other by six first bridge patterns 212. An increase in the number of first bridge patterns 212 arranged in the first direction DR1 crossing the second direction DR2, which is the extension direction of the first electrode 210, may correspond to an increase in a number of signal paths. Accordingly, as the number of signal paths increases, the resistance of the first electrode 210 may decrease. As a result, the sensing sensitivity of the sensor layer 200 may be improved.

The second electrode 220 may include a plurality of first split electrodes 220-dp spaced apart from each other in the second direction DR2. Each of the first split electrodes 220-dp may extend in the first direction DR1, and the first split electrodes 220-dp may be spaced apart from each other in the second direction DR2. The first split electrodes 220-dp may be included in the second conductive layer SU204. Three first split electrodes 220-dp included in one second electrode 220 may be connected to one second trace line 220t (e.g., see FIG. 8).

The charging electrode 230 may include a plurality of second split electrodes 230-dp spaced apart from each other in the first direction DR1. Each of the second split electrodes 230-dp may extend along the second direction DR2. The second split electrodes 230-dp may be spaced apart from each other in the first direction DR1. When viewed in the third direction DR3 (e.g., in a plan view), the second split electrodes 230-dp may at least partially overlap with the first patterns 211.

Referring to FIGS. 8 and 9A together, one loop trace line 230rt is electrically connected to one first electrode group 230pc, which may include two charging electrodes 230. In this case, one loop trace line 230rt may be electrically connected to six second split electrodes 230-dp. In this case, a degree of an increase in the number of pads within the sensor layer 200 may be reduced.

The fourth electrode 240 may include a plurality of third split electrodes 240-dp spaced apart from each other in the second direction DR2. Each of the third split electrodes 240-dp may extend along the first direction DR1. Each of the third split electrodes 240-dp may include a plurality of second patterns 241, and a plurality of second bridge patterns 242 electrically connected to the second patterns 241. The second patterns 241 and the second bridge patterns 242 may be electrically connected to each other through contact holes defined in the intermediate insulating layer 203 (e.g., see FIG. 7A). Two adjacent second patterns 241 may be spaced apart from each other with one second split electrode 230-dp and two first bridge patterns 212 interposed therebetween.

FIGS. 9A and 9B illustrate an example in which one sensing unit SU includes three first split electrodes 220-dp, three second split electrodes 230-dp, and three third split electrodes 240-dp, but the present disclosure is not limited thereto. For example, each of the number of first split electrodes 220-dp, the number of second split electrodes 230-dp, and the number of third split electrodes 240-dp included in one sensing unit SU may be one, two, or four or more.

In an embodiment of the present disclosure, a first capacitor may be defined between the first electrode 210 and the charging electrode 230, and a second capacitor may be defined between the second electrode 220 and the fourth electrode 240. A first capacitance of the first capacitor and a second capacitance of the second capacitance may be adjusted by the overlapping area between the first electrode 210 and the charging electrode 230 and the overlapping area between the second electrode 220 and the fourth electrode 240.

As the first and second capacitances increase, an amount of an induced current transferred from the charging electrode 230 to the first electrode 210 may increase, and an amount of an induced current transferred from the fourth electrode 240 to the second electrode 220 may increase. Accordingly, as the first and second capacitances increase, the pen sensing performance of the sensor layer 200 may be improved. In addition, during a touch sensing, the first and second capacitances may act as loads. Therefore, as the first and second capacitances decrease, the touch sensing performance may be improved.

In an embodiment of the present disclosure, the overlapping area between the first electrode 210 and the charging electrode 230 and the overlapping area between the second electrode 220 and the fourth electrode 240 may be easily adjusted. Accordingly, it may be possible to provide the sensor layer 200 having capacitances at appropriate levels in consideration of a touch sensitivity and a pen sensing sensitivity. As a result, the electronic device 1000 (e.g., see FIG. 2A) with both an improved pen sensitivity and an improved touch sensitivity may be provided.

In an embodiment of the present disclosure, in the second conductive layer SU204 within one sensing unit SU, the area occupied by the components included in the first electrode 210 and the second electrode 220 may be larger than the area occupied by the components included in the charging electrode 230 and the fourth electrode 240. A change in capacitance due to the first input 2000 (e.g., see FIG. 6) may be larger as a distance decreases. Therefore, the components configured to sense the first input 2000 (e.g., see FIG. 6) may be disposed in a relatively larger area in a layer adjacent to (e.g., closer to) the surface of the electronic device 1000 (e.g., see FIG. 1). As a result, the touch performance may be improved.

Referring to FIGS. 9A, 9B, and 10, each of the first electrode 210, the second electrode 220, the charging electrode 230, and the fourth electrode 240 may have a mesh structure. The mesh structure may be a structure in which a plurality of openings 200OP are defined. In FIG. 10, each of the plurality of openings 200OP is illustrated as having a circular shape having a curvature (e.g., a predetermined curvature), but the present disclosure is not particularly limited thereto. For example, each of the openings 200OP may be modified to have various suitable shapes, such as a quadrilateral, a polygon, or an irregular shape.

FIG. 10 illustrates portions of the first pattern 211, the second bridge pattern 242, and the second electrode 220 disposed in the second conductive layer SU204. The first pattern 211, the second bridge pattern 242, and the second electrode 220 may be electrically insulated from each other. For example, the first pattern 211, the second bridge pattern 242, and the second electrode 220 may be electrically insulated from each other by a first line CLa extending along a first crossing direction CDR1 crossing the first direction DR1 and the second direction DR2, and a second line CLb extending along a second crossing direction CDR2 crossing the first crossing direction CDR1. A portion of the conductive layer and another portion thereof may be spaced apart from each other with the first line CLa and the second line CLb interposed therebetween.

FIG. 11 illustrates an operation of the sensor driver 200C according to an embodiment of the present disclosure.

Referring to FIGS. 6 and 11, the sensor driver 200C may be selectively driven in any one of a first operation mode DMD1, a second operation mode DMD2, and/or a third operation mode DMD3.

The first operation mode DMD1 may be referred to as a touch and pen standby mode, the second operation mode DMD2 may be referred to as a touch activation and pen standby mode, and the third operation mode DMD3 may be referred to as a pen activation mode. The first operation mode DMD1 may be a mode that stands by for the first input 2000 and the second input 3000. The second operation mode DMD2 may be a mode that senses the first input 2000, and stands by for the second input 3000. The third operation mode DMD3 may be a mode that senses the second input 3000.

In an embodiment of the present disclosure, the sensor driver 200C may first be driven in the first operation mode DMD1. When the first input 2000 is sensed in the first operation mode DMD1, the sensor driver 200C may be switched (or changed) to the second operation mode DMD2. As another example, when the second input 3000 is sensed in the first operation mode DMD1, the sensor driver 200C may be switched (or changed) to the third operation mode DMD3.

In an embodiment of the present disclosure, when the second input 3000 is sensed in the second operation mode DMD2, the sensor driver 200C may be switched to the third operation mode DMD3. When the first input 2000 is released (or not detected) in the second operation mode DMD2, the sensor driver 200C may be switched to the first operation mode DMD1. When the second input 3000 is released (or not detected) in the third operation mode DMD3, the sensor driver 200C may be switched to the first operation mode DMD1.

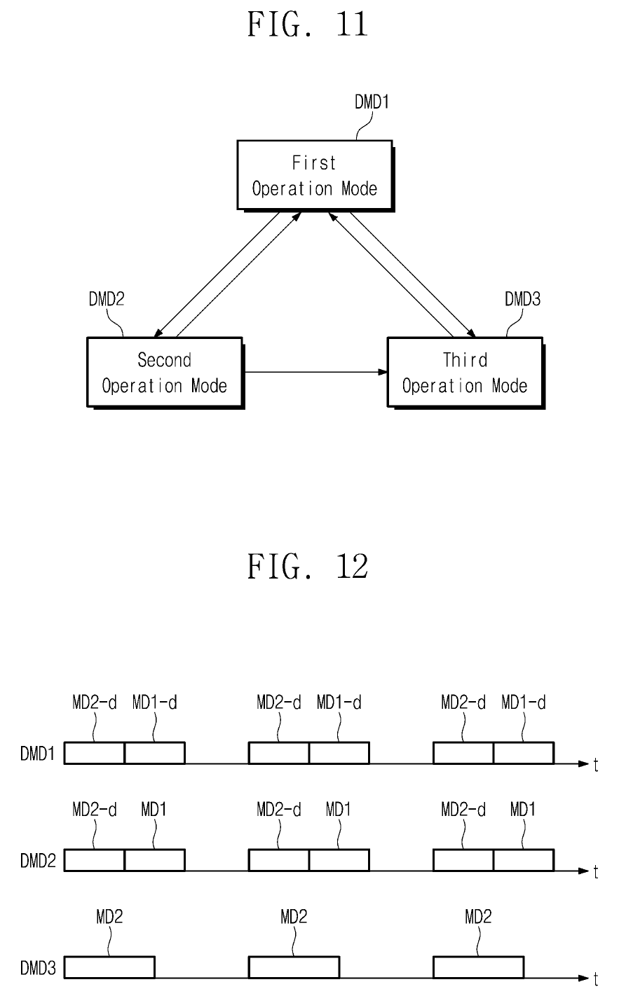

FIG. 12 illustrates an operation of the sensor driver 200C according to an embodiment of the present disclosure.

Referring to FIGS. 6, 11 and 12, the operations in the first to third operation modes DMD1, DMD2, and DMD3 are illustrated as an example in chronological order of time t.

In the first operation mode DMD1, the sensor driver 200C may be repeatedly driven in a second mode MD2-d and a first mode MD1-d. During the second mode MD2-d, the sensor layer 200 may be scan-driven to detect the second input 3000. During the first mode MD1-d, the sensor layer 200 may be scan-driven to detect the first input 2000. In FIG. 12, the sensor driver 200C is illustrated as operating in the first mode MD1-d consecutively after the second mode MD2-d, but the order is not limited thereto.

In the second operation mode DMD2, the sensor driver 200C may be repeatedly driven in a second mode MD2-d and a first mode MD1. During the second mode MD2-d, the sensor layer 200 may be scan-driven to detect the second input 3000. During the first mode MD1, the sensor layer 200 may be scan-driven to detect coordinates based on the first input 2000.

In the third operation mode DMD3, the sensor driver 200C may be driven in a second mode MD2. During the second mode MD2, the sensor layer 200 may be scan-driven to detect coordinates based on the second input 3000. In the third operation mode DMD3, the sensor driver 200C may not be driven in the first mode MD1-d or MD1 until the second input 3000 is released (or not detected).

Referring to FIG. 8 together, in the first mode MD1-d and the first mode MD1, the charging electrodes 230 and the fourth electrodes 240 may both be grounded or applied with a constant voltage. As another example, in the first mode MD1-d and the first mode MD1, the charging electrodes 230 and the fourth electrodes 240 may both be floating (e.g., electrically floating). As another example, in the first mode MD1-d and the first mode MD1, a signal in phase with a transmission signal provided to the first electrodes 210 may be applied to the charging electrodes 230 and the fourth electrodes 240. In this case, a touch noise may be prevented or substantially prevented from being introduced through the charging electrodes 230 and the fourth electrodes 240.

In the second mode MD2-d and the second mode MD2, one ends of the charging electrodes 230 and the fourth electrodes 240 may all be floating. In addition, in the second mode MD2-d and the second mode MD2, other ends of the charging electrodes 230 and the fourth electrodes 240 may all be grounded or floating. Therefore, a compensation for a sensing signal may be maximized by the coupling between the first electrodes 210 and the charging electrodes 230 and the coupling between the second electrodes 220 and the fourth electrodes 240.

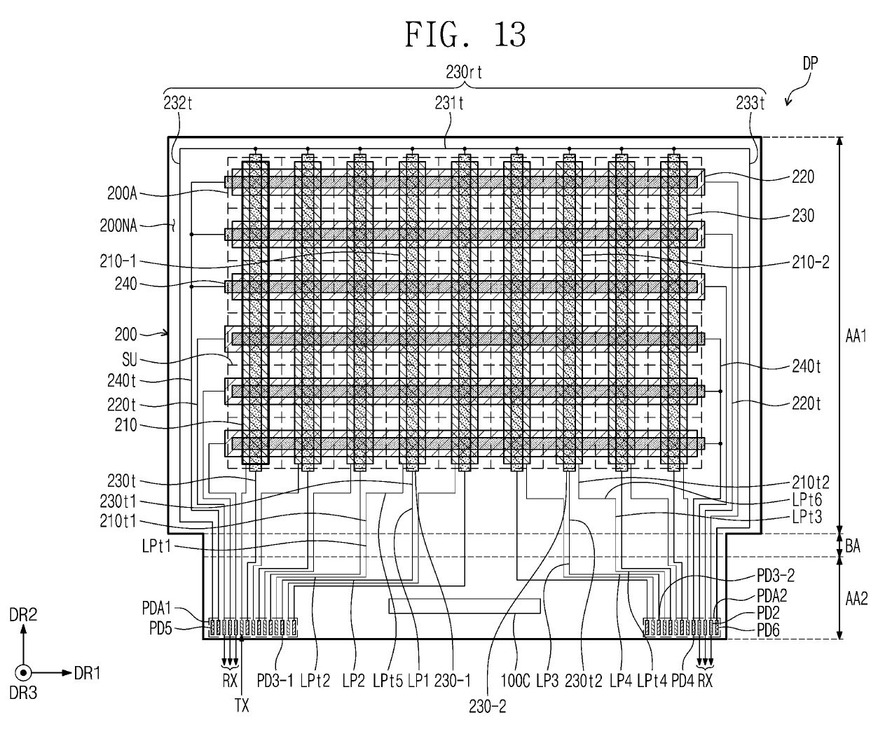

FIG. 13 illustrates the first mode MD1-d or MD1 according to an embodiment of the present disclosure.

Referring to FIGS. 6, 12 and 13, the first mode MD1-d of the first operation mode DMD1 and the first mode MD1 of the second operation mode DMD2 may include a mutual capacitance detection mode. FIG. 13 illustrates the mutual capacitance detection mode in the first mode MD1-d of the first operation mode DMD1 and the first mode MD1 of the second operation mode DMD2.

In the mutual capacitance detection mode, the sensor driver 200C may sequentially provide a transmission signal TX to the first electrodes 210, and may detect coordinates for the first input 2000 using a reception signal RX detected through the second electrodes 220. For example, the sensor driver 200C may sense a change in a mutual capacitance between the first electrodes 210 and the second electrodes 220, and may calculate input coordinates.

FIG. 13 illustrates an example in which the transmission signal TX is provided to one first electrode 210, and the reception signal RX is output from the second electrodes 220. In order to illustrate a signal representation, one first electrode 210 to which the transmission signal TX is provided is indicated in bold in FIG. 13. The sensor driver 200C may detect the input coordinates for the first input 2000 by sensing a change in a capacitance between the first electrode 210 and each of the second electrodes 220.

In another embodiment of the present disclosure, at least any one of the first mode MD1-d of the first operation mode DMD1 and/or the first mode MD1 of the second operation mode DMD2 may further include a self-capacitance detection mode. The sensor driver 200C may output driving signals to the first electrodes 210 and the second electrodes 220 in the self-capacitance detection mode, and may calculate input coordinates by sensing a change in the capacitance of each of the first electrodes 210 and the second electrodes 220.

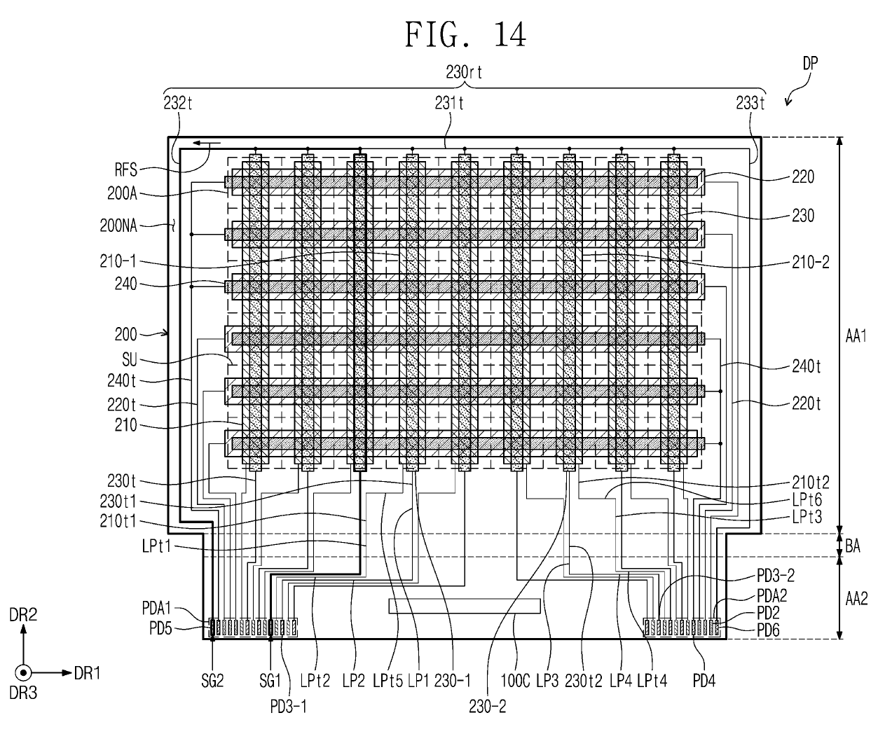

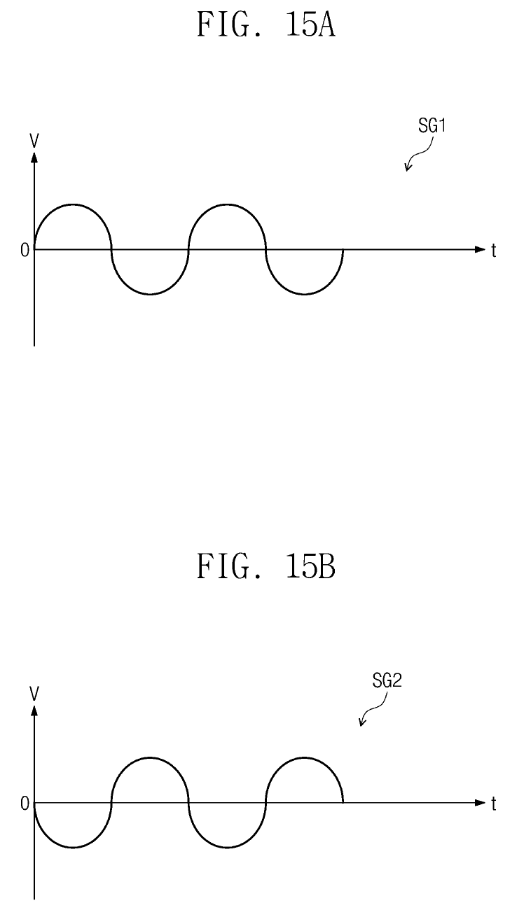

FIG. 14 illustrates a second mode, such as a charging driving mode, according to an embodiment of the present disclosure. FIG. 15A is a graph illustrating a waveform of a first signal SG1 according to an embodiment of the present disclosure. FIG. 15B is a graph illustrating a waveform of a second signal SG2 according to an embodiment of the present disclosure.

Referring to FIGS. 6, 12, 14, 15A and 15B, the second mode MD2 may include a charging driving mode. The charging driving mode may include a searching charging driving mode and a tracking charging driving mode. However, the present disclosure is not limited thereto, and the charging driving mode may include only a single charging driving mode.

The searching charging driving mode may be a driving mode prior to sensing the position of a pen PN. Accordingly, the sensor layer 200 may sequentially output the first signal SG1 or the second signal SG2 to all the pads PD1, PD2, PD3, PD4, PD5, and PD6 included in the sensor layer 200. In other words, the entire region of the sensor layer 200 may be sequentially scanned in the searching charging driving mode. When the pen PN is sensed in the searching charging driving mode, the sensor layer 200 may be driven in the tracking charging driving mode. For example, in the tracking charging driving mode, the sensor driver 200C may sequentially output the first signal SG1 and the second signal SG2 to a region overlapping with a point at which the pen PN is sensed, rather than to the entire sensor layer 200.

In the charging driving mode, the sensor driver 200C may output the first signal SG1 to at least one pad, and may output the second signal SG2 to at least one other pad. The second signal SG2 may be a reverse signal of the first signal SG1. For example, the first signal SG1 may be a sinusoidal signal.

Because the first signal SG1 and the second signal SG2 are output to at least two pads, a current RFS may have a current path through which it flows from one or more pads to another one or more pads. The current path may also be referred to as a charging loop. In addition, because the first signal SG1 and the second signal SG2 may be sinusoidal signals having a reverse phase relationship with each other, the direction of the current RFS may change periodically. In another embodiment of the present disclosure, the first signal SG1 and the second signal SG2 may be square wave signals having a reverse phase relationship with each other.

When the first signal SG1 and the second signal SG2 have a reverse phase relationship with each other, a noise caused by the first signal SG1 in the display layer 100 may be offset by a noise caused by the second signal SG2. Therefore, a flicker phenomenon may not occur in the display layer 100, and thus, the display quality of the display layer 100 may be improved.

In another embodiment of the present disclosure, the first signal SG1 may be a sinusoidal signal. However, the present disclosure is not limited thereto, and the first signal SG1 may be a square wave signal. The second signal SG2 may have a constant voltage (e.g., a predetermined constant voltage). For example, the second signal SG2 may be a ground voltage. In other words, a pad to which the second signal SG2 is applied may be considered to be grounded. Even in this case, the current RFS may flow from one or more pads to another pad. In addition, even though the other pad is grounded, the direction of the current RFS may periodically change because the first signal SG1 may be a sinusoidal signal or a square wave signal.

FIG. 14 illustrates that the first signal SG1 is provided to one charging pad PD3 connected to one charging trace line 230t, and that the second signal SG2 is provided to the fifth pad PD5 connected to the second line portion 232t of the loop trace line 230rt. The current RFS may flow into a charging loop defined by one charging trace line 230t, one charging electrode 230 connected to the one charging trace line 230t, and a portion of the loop trace line 230rt. The charging loop may have a coil shape. Therefore, in the charging driving mode of the second mode MD2-d or MD2, the resonant circuit of the pen PN may be charged by the charging loop.

According to some embodiments of the present disclosure, the charging loop of the loop coil pattern may be implemented by the components included in the sensor layer 200. Accordingly, the electronic device 1000 (e.g., see FIG. 1) may charge the pen PN by using the sensor layer 200. Therefore, because an additional component having a coil for charging the pen PN (e.g., a digitizer or the like) is not used, an increase in the thickness and the weight of the electronic device 1000 (e.g., see FIG. 1) and a decrease in its flexibility due to the addition of the additional component may be avoided.

In the charging driving mode, the first electrodes 210, the second electrodes 220, and the fourth electrodes 240 may be grounded, may be applied with a constant voltage, or may be electrically floating. In more detail, the first electrodes 210, the second electrodes 220, and the fourth electrodes 240 may be floating. In other words, a signal may not be provided to the pads PD1, PD2, and PD4 connected to the first electrodes 210, the second electrodes 220, and the fourth electrodes 240. In this case, the current RFS may not flow to the first electrodes 210, the second electrodes 220, and the fourth electrodes 240.

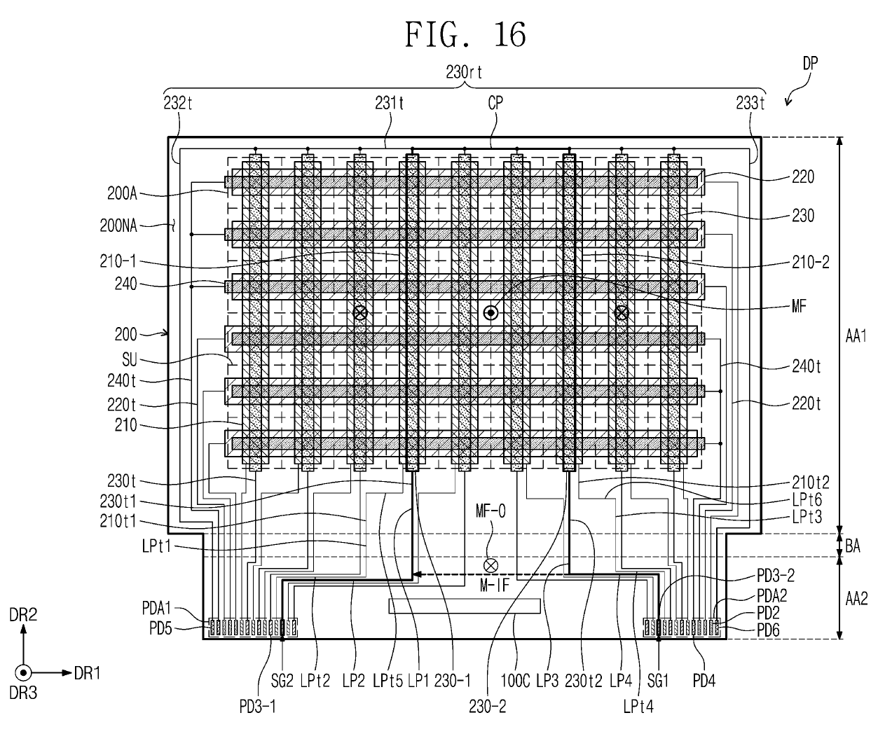

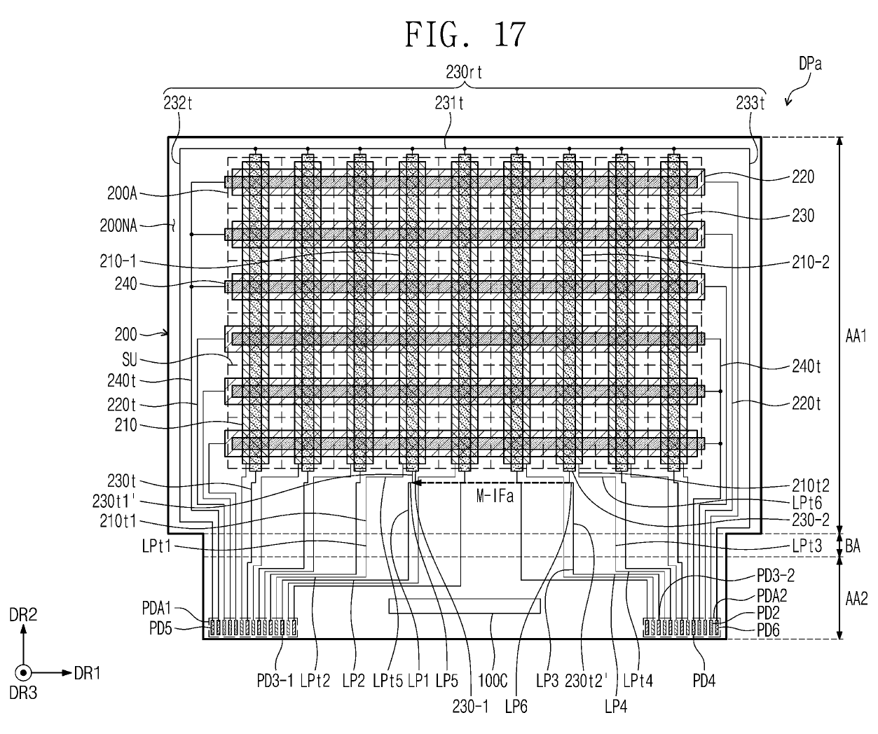

FIG. 16 illustrates the second mode, such as the charging driving mode, according to an embodiment of the present disclosure.

Referring to FIGS. 6, 8, 14, 15A, 15B and 16, in the charging driving mode, the sensor driver 200C may output the first signal SG1 to the second charging pad PD3-2 electrically connected to the second charging electrode 230-2, and may output the second signal SG2 different from the first signal SG1 to the first charging pad PD3-1 electrically connected to the first charging electrode 230-1.

In an embodiment of the present disclosure, the first charging pad PD3-1 may be disposed in the first pad region PDA1, and the second charging pad PD3-2 may be disposed in the second pad region PDA2 spaced apart from the first pad region PDA1 in the first direction DR1. Accordingly, in the sensor layer 200, a charging loop CP may be formed in a direction through the second charging pad PD3-2 disposed in the second pad region PDA2, the second charging trace line 230t2, the second charging electrode 230-2, a portion of the loop trace line 230rt, the first charging electrode 230-1, the first charging trace line 230t1, and the first charging pad PD3-1. In addition, the charging loop may be formed in a direction opposite to the direction.

According to an embodiment of the present disclosure, in the first region AA1, the first charging trace line 230t1 may include a first charging trace line portion LP1 extending in the second direction DR2 that is the same as the extension direction of the first charging electrode 230-1, and the second charging trace line 230t2 may include a third charging trace line portion LP3 extending in the second direction DR2 that is the same as the extension direction of the second charging electrode 230-2.

Accordingly, in the first region AA1, the charging loop CP may be formed through the third charging trace line portion LP3 of the second charging trace line 230t2, the second charging electrode 230-2, a portion of the loop trace line 230rt, the first charging electrode 230-1, and the first charging trace line portion LP1 of the first charging trace line 230t1.

In other words, in the first region AA1, the charging loop CP may generate a magnetic field MF in the same direction. For example, the charging loop CP formed through the third charging trace line portion LP3 of the second charging trace line 230t2, the second charging electrode 230-2, a portion of the loop trace line 230rt, the first charging electrode 230-1, and the first charging trace line portion LP1 of the first charging trace line 230t1 may generate the magnetic field MF directed in the third direction DR3 in a region within the charging loop CP. Accordingly, the charging loop CP according to an embodiment of the present disclosure may reinforce the magnetic field, and the charging performance of the pen PN may be improved.

According to an embodiment of the present disclosure, in the second region AA2, the first charging trace line 230t1 may include a second charging trace line portion LP2 extending in the first direction DR1 crossing the extension direction of the first charging electrode 230-1, and the second charging trace line 230t2 may include a fourth charging trace line portion LP4 extending in the first direction DR1 crossing the extension direction of the second charging electrode 230-2.

Accordingly, in the second region AA2, the charging loop CP may be formed through the second charging pad PD3-2, the fourth charging trace line portion LP4 of the second charging trace line 230t2, a portion of the third charging trace line portion LP3 of the second charging trace line 230t2, a portion of the first charging trace line portion LP1 of the first charging trace line 230t1, the second charging trace line portion LP2 of the first charging trace line 230t1, and the first charging pad PD3-1.

In other words, in the second region AA2, the charging loop CP may not actually have a wiring line, but a flow of a macroscopic current M-IF may occur, such as the flow of the current M-IF flowing in a direction opposite to the first direction DR1, from the fourth charging trace line portion LP4 of the second charging trace line 230t2 to the second charging trace line portion LP2 of the first charging trace line 230t1.

According to some embodiments of the present disclosure, even though a magnetic field MF-O is generated by the flow of the current M-IF flowing in the second region AA2, because the second region AA2 is bent below the first region AA1 by the bending region BA, and a magnetic field shielding process is performed between the first region AA1 and the second region AA2, the magnetic field MF-O generated in the second region AA2 may not affect the magnetic field MF formed in the first region AA1.

Accordingly, in the second region AA2, even though the first charging trace line 230t1 and the second charging trace line 230t2 extend in the first direction DR1 crossing the extension direction of the first charging electrode 230-1 and the second charging electrode 230-2, the magnetic field MF-O generated in the second region AA2 may not affect the magnetic field formed in the first region AA1. Accordingly, the strength of the magnetic field MF formed in the first region AA1 may not be offset, and during the charging operation of the sensor layer 200, the sensor layer 200 may form a uniform or substantially uniform magnetic field across the entire area of the sensing region 200A. Therefore, the sensitivity of the pen PN and the touch performance of the sensor layer 200 may be improved.

FIG. 17 illustrates a display panel DPa according to an embodiment of the present disclosure. Hereinafter with reference to FIG. 17, redundant description of the same or substantially the same components as those described above with refence to FIG. 8 may not be repeated, and the differences from FIG. 8 may be mainly described.

Referring to FIG. 17, a first charging trace line 230t1’ may further include a fifth charging trace line portion LP5 disposed in the first region AA1 and extending in the first direction DR1. A second charging trace line 230t2’ may further include a sixth charging trace line portion LP6 disposed in the first region AA1 and extending in the first direction DR1.

In an embodiment of the present disclosure, the length of the fifth charging trace line portion LP5 of the first charging trace line 230t1’ may be shorter than the length of the second charging trace line portion LP2 of the first charging trace line 230t1’, and the length of the sixth trace line portion LP6 of the second charging trace line 230t2’ may be shorter than the length of the fourth charging trace line portion LP4 of the second charging trace line 230t2’.

According to some embodiments of the present disclosure, in the first region AA1, by designing the length of the fifth charging trace line portion LP5 of the first charging trace line 230t1’ and the length of the sixth trace line portion LP6 of the second charging trace line 230t2’ to be as short as possible, a portion that generates a magnetic field in a direction different from that of the magnetic field generated in the sensing region 200A may be minimized or reduced. For example, at the lower end of the first region AA1 adjacent to the bending region BA, a flow of a macroscopic current M-Ifa generated according to the shapes of the first charging trace line 230t1’ and the second charging trace line 230t2’ may be eliminated or weakened. Accordingly, because the magnetic field generated by the flow of the current M-IFa is eliminated or the intensity of the magnetic field is reduced, a phenomenon in which the magnetic field is offset in the lower region of the sensing region 200A adjacent to the first pad region PDA1 and the second pad region PDA2 may be reduced or minimized.

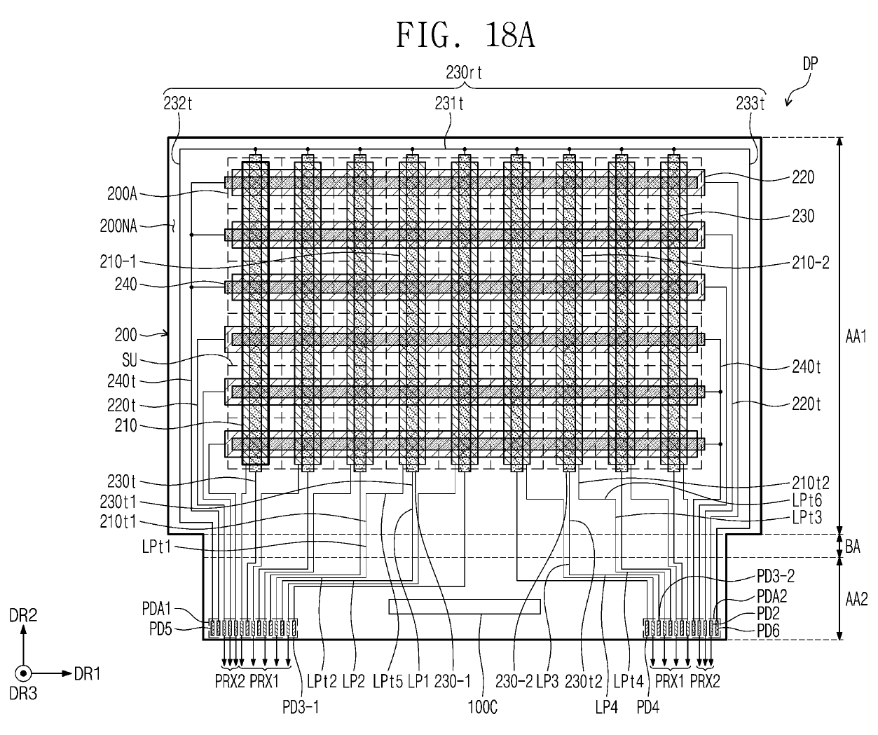

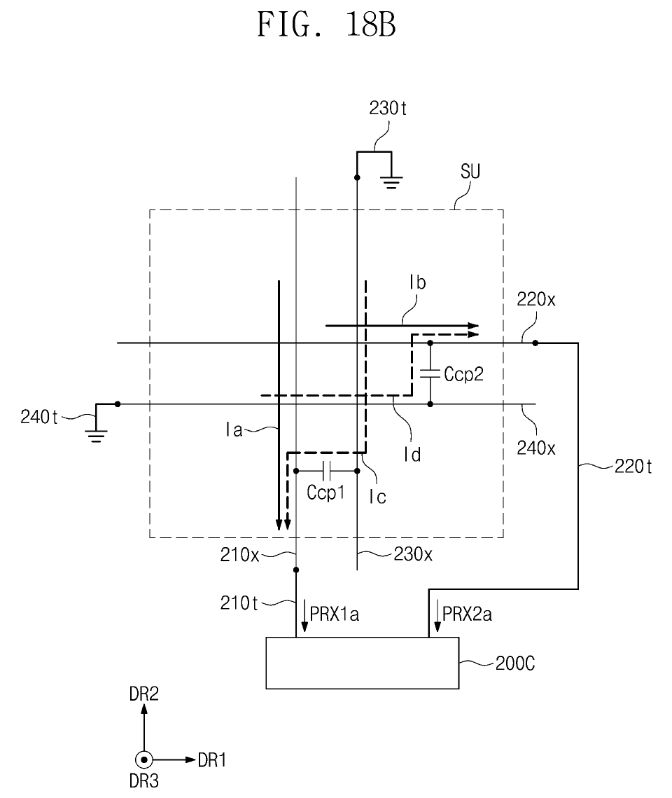

FIG. 18A illustrates the second mode according to an embodiment of the present disclosure. FIG. 18B illustrates the second mode based on one sensing unit according to an embodiment of the present disclosure.

Referring to FIGS. 18A and 18B, the second mode may include a charging driving mode and a pen sensing driving mode. FIGS. 18A and 18B illustrate the pen sensing driving mode.

Referring to FIG. 18A, in the pen sensing driving mode, first reception signals PRX1 may be output from the first electrodes 210, and second reception signals PRX2 may be output from the second electrodes 220. FIG. 18B illustrates one sensing unit SU through which first to fourth induced currents Ia, Ib, Ic, and Id generated by the pen PN (e.g., see FIG. 6) flow.

Referring to FIGS. 18A and 18B, in an embodiment of the present disclosure, routing directions of one electrode and another electrode of the sensor layer 200, which overlaps with each other, may be different from each other. For example, the routing direction of a first electrode 210x and the routing direction of a charging electrode 230x may be different from each other. In addition, the routing direction of a second electrode 220x and the routing direction of a fourth electrode 240x may be different from each other. For example, in FIG. 18B, the first electrode 210x and the first trace line 210t may be connected to each other below the sensing unit SU, and the charging electrode 230x and the charging trace line 230t may be connected to each other above the sensing unit SU. The second electrode 220x and the second trace line 220t may be connected to each other on the right side of the sensing unit SU, and the fourth electrode 240x and the fourth trace line 240t may be connected to each other on the left side of the sensing unit SU.

The RLC resonance circuit of the pen PN (e.g., see FIG. 6) may emit a magnetic field at a resonant frequency while discharging a stored electric charge. By the magnetic field provided from the pen PN (e.g., see FIG. 6), the first induced current Ia may be generated in the first electrode 210x, and the second induced current Ib may be generated in the second electrode 220x. In addition, the third induced current Ic may be generated in the charging electrode 230x, and the fourth induced current Id may be generated in the fourth electrode 240x.

A first coupling capacitor Ccp1 may be formed between the charging electrode 230x and the first electrode 210x, and a second coupling capacitor Ccp2 may be formed between the fourth electrode 240x and the second electrode 220x. The third induced current Ic may be transferred to the first electrode 210x through the first coupling capacitor Ccp1, and the fourth induced current Id may be transferred to the second electrode 220x through the second coupling capacitor Ccp2.

The sensor driver 200C may receive a first reception signal PRX1a based on the first induced current Ia and the third induced current Ic from the first electrode 210x, and a second reception signal PRX2a based on the second induced current Ib and the fourth induced current Id from the second electrode 220x. The sensor driver 200C may detect the input coordinates of the pen PN (e.g., see FIG. 6) based on the first reception signal PRX1a and the second reception signal PRX2a.

The sensor driver 200C may receive the first reception signal PRX1a from the first electrode 210x and the second reception signal PRX2a from the second electrode 220x. In this case, one ends of the charging electrode 230x and the fourth electrode 240x may be floating. Therefore, a compensation for a sensing signal may be maximized by the coupling between the first electrode 210x and the charging electrode 230x and the coupling between the second electrode 220x and the fourth electrode 240x.

In addition, other ends of the charging electrode 230x and the fourth electrode 240x may be grounded or floating. Therefore, the third induced current Ic and the fourth induced current Id may be sufficiently transferred to the first electrode 210x and the second electrode 220x by the coupling between the first electrode 210x and the charging electrode 230x and the coupling between the second electrode 220x and the fourth electrode 240x.

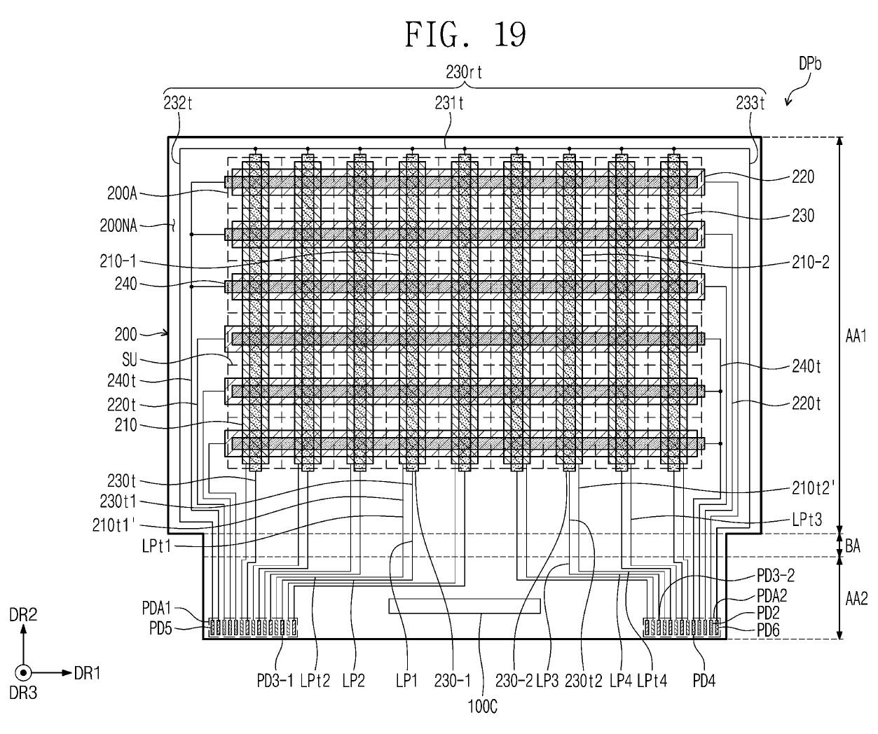

FIG. 19 illustrates a display panel DPb according to an embodiment of the present disclosure. Hereinafter with reference to FIG. 19, redundant description of the same or substantially the same components as those described above with refence to FIGS. 8 and 18A may not be repeated, and the differences from FIGS. 8 and 18A may be mainly described.

Referring to FIG. 19, the (1-1)-th trace line 210t1’ may include a first trace line portion LPt1 disposed in the first region AA1 and extending in the second direction DR2, and a second trace line portion LPt2 disposed in the second region AA2 and extending in the first direction DR1. The (1-2)-th trace line 210t2’ may include a third trace line portion LPt3 disposed in the first region AA1 and extending in the second direction DR2, and a fourth trace line portion LPt4 disposed in the second region AA2 and extending in the first direction DR1. In other words, compared to the embodiment described above with reference to FIG. 8, the (1-1)-th trace line 210t1’ of FIG. 19 may not include a fifth trace line portion LPt5 disposed in the first region AA1 and extending in the first direction DR1, and the (1-2)-th trace line 210t2’ may not include a sixth trace line portion LPt6 disposed in the first region AA1 and extending in the first direction DR1.

According to some embodiments of the present disclosure, because the fifth trace line portion LPt5 of the (1-1)-th trace line 210t1’ and the sixth trace line portion LPt6 of the (1-2)-th trace line 210t2’, which generate the magnetic fields of different directions from each other in the pen sensing driving mode, are removed, the magnetic fields may not be offset when the pen PN is discharged, such that the intensity of the current induced by the magnetic field may be increased. In other words, the touch performance of the electronic device 1000 (e.g., see FIG. 1) may be improved.

According to some embodiments described above, in the first region, the first charging trace line and the second charging trace line may extend in the second direction that is the same as the extension direction of the first charging electrode and the second charging electrode. Therefore, in the first region, even though the first charging trace line and the second charging trace line respectively extend toward the pad regions that are spaced apart from each other, a current flowing through the first charging trace line, the first charging electrode, the second charging electrode, and the second charging trace line in the first region may flow in a constant loop direction. In this case, the current flowing in the constant loop direction in the first region may reinforce a magnetic field. For example, when the pen is being charged, the current flowing in the constant loop direction may generate a magnetic field in the same direction, thus reinforcing the magnetic field. The reinforced magnetic field may improve the charging performance of the pen, thus enhancing the touch performance of the electronic device.

The foregoing is illustrative of some embodiments of the present disclosure, and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

What is claimed is:

1. An electronic device comprising:
a display panel having a first region, a bending region, and a second region, and comprising a display layer and a sensor layer; and
a sensor driver configured to drive the sensor layer,
wherein the sensor layer comprises:
a plurality of first electrodes in the first region along a first direction;
a plurality of second electrodes in the first region along a second direction crossing the first direction;
a first charging electrode in the first region, and overlapping with at least one first electrode among the plurality of first electrodes;
a second charging electrode in the first region, and overlapping with at least one other first electrode among the plurality of first electrodes;
a first charging trace line electrically connected to the first charging electrode and the sensor driver, the first charging trace line comprising a first charging trace line portion in the first region and extending in the second direction, and a second charging trace line portion in the second region and extending in the first direction; and
a second charging trace line electrically connected to the second charging electrode and the sensor driver, the second charging trace line comprising a third charging trace line portion in the first region and extending in the second direction, and a fourth charging trace line portion in the second region and extending in the first direction.

2. The electronic device of claim 1, wherein:
a first pad region on one side and a second pad region spaced from the first pad region on another side in the first direction are located in the second region; and
the sensor layer further comprises:
a first charging pad in the first pad region, and electrically connected to the first charging electrode; and
a second charging pad in the second pad region, and electrically connected to the second charging electrode.

3. The electronic device of claim 2, wherein the sensor driver is configured to selectively operate in a first mode for sensing a touch input, or in a second mode for sensing a pen input, and
wherein the second mode comprises a charging driving mode and a pen sensing driving mode.

4. The electronic device of claim 3, wherein, in the charging driving mode, the sensor driver is configured to output a first signal to the second charging pad, and output a second signal different from the first signal to the first charging pad to form a charging loop in the sensor layer.

5. The electronic device of claim 1, wherein:
the first charging trace line further comprises a fifth charging trace line portion in the first region, and extending in the first direction; and
the second charging trace line further comprises a sixth charging trace line portion in the first region, and extending in the first direction.

6. The electronic device of claim 5, wherein:
a length of the fifth charging trace line portion is shorter than a length of the second charging trace line portion; and
a length of the sixth charging trace line portion is shorter than a length of the fourth charging trace line portion.

7. The electronic device of claim 1, wherein the sensor layer further comprises:
a (1-1)-th trace line electrically connected to the sensor driver and the at least one first electrode among the plurality of first electrodes; and
a (1-2)-th trace line electrically connected to the sensor driver and the at least one other first electrode among the plurality of first electrodes.

8. The electronic device of claim 7, wherein:
the (1-1)-th trace line comprises:
a first trace line portion in the first region, and extending in the second direction; and
a second trace line portion in the second region, and extending in the first direction; and
the (1-2)-th trace line comprises:
a third trace line portion in the first region, and extending in the second direction; and
a fourth trace line portion in the second region, and extending in the first direction.

9. The electronic device of claim 8, wherein:
the (1-1)-th trace line further comprises a fifth trace line portion in the first region, and extending in the first direction; and
the (1-2)-th trace line further comprises a sixth trace line portion in the first region, and extending in the first direction.

10. The electronic device of claim 7, wherein:
a first pad region on one side and a second pad region spaced from the first pad region on another side in the first direction are located in the second region; and
the sensor layer further comprises:
a (1-1)-th pad in the first pad region, and electrically connected to the at least one first electrode among the plurality of first electrodes; and
a (1-2)-th pad in the second pad region, and electrically connected to the at least one other first electrode among the plurality of first electrodes.

11. The electronic device of claim 10, wherein the sensor driver is configured to selectively operate in a first mode for sensing a touch input, or in a second mode for sensing a pen input,
wherein the second mode comprises a charging driving mode and a pen sensing driving mode, and
wherein, in the pen sensing driving mode, the sensor driver is configured to receive a reception signal from the at least one first electrode and the at least one other first electrode among the plurality of first electrodes.

12. The electronic device of claim 1, wherein:
the first charging trace line portion is in direct contact with the first charging electrode; and
the third charging trace line portion is in direct contact with the second charging electrode.

13. An electronic device comprising:
a display panel having a first region, a bending region, and a second region, and comprising a sensor layer; and
a processor configured to control an operation of the display panel,
wherein:
a first pad region and a second pad region spaced from the first pad region in a first direction are located in the second region; and
the sensor layer comprises:
a first charging electrode in the first region;
a second charging electrode in the first region;
a first charging pad in the first pad region, and electrically connected to the first charging electrode;
a second charging pad in the second pad region, and electrically connected to the second charging electrode;
a first charging trace line electrically connecting the first charging electrode and the first charging pad to each other, the first charging trace line comprising a first charging trace line portion in the first region and extending in a second direction crossing the first direction, and a second charging trace line portion in the second region and extending in the first direction; and
a second charging trace line electrically connecting the second charging electrode and the second charging pad to each other, the second charging trace line comprising a third charging trace line portion in the first region and extending in the second direction, and a fourth charging trace line portion in the second region and extending in the first direction.

14. The electronic device of claim 13, further comprising a sensor driver configured to selectively operate in a first mode for sensing a touch input, or in a second mode for sensing a pen input,
wherein the second mode comprises a charging driving mode and a pen sensing driving mode, and
wherein, in the charging driving mode, the sensor driver is configured to output a first signal to the second charging pad, and a second signal different from the first signal to the first charging pad to form a charging loop in the sensor layer.

15. The electronic device of claim 13, wherein:
the first charging trace line further comprises a fifth charging trace line portion in the first region, and extending in the first direction; and
the second charging trace line further comprises a sixth charging trace line portion in the first region, and extending in the first direction.

16. The electronic device of claim 15, wherein:
a length of the fifth charging trace line portion is shorter than a length of the second charging trace line portion; and
a length of the sixth charging trace line portion is shorter than a length of the fourth charging trace line portion.

17. The electronic device of claim 13, wherein the sensor layer further comprises:
a plurality of first electrodes in the first region along the first direction; and
a plurality of second electrodes in the first region along the second direction, and
wherein:
the first charging electrode overlaps with at least one first electrode among the plurality of first electrodes; and
the second charging electrode overlaps with at least one other first electrode among the plurality of first electrodes.

18. The electronic device of claim 17, wherein the sensor layer further comprises:
a (1-1)-th trace line electrically connected to the at least one first electrode among the plurality of first electrodes; and
a (1-2)-th trace line electrically connected to the at least one other first electrode among the plurality of first electrodes, and
wherein:
the (1-1)-th trace line comprises a first trace line portion in the first region and extending in the second direction, and a second trace line portion in the second region and extending in the first direction; and
the (1-2)-th trace line comprises a third trace line portion in the first region and extending in the second direction, and a fourth trace line portion in the second region and extending in the first direction.

19. The electronic device of claim 18, wherein:
the (1-1)-th trace line further comprises a fifth trace line portion in the first region, and extending in the first direction; and
the (1-2)-th trace line further comprises a sixth trace line portion in the first region, and extending in the first direction.

20. The electronic device of claim 13, wherein:
the first charging trace line portion is in direct contact with the first charging electrode; and
the third charging trace line portion is in direct contact with the second charging electrode.
